(19) United States
(12) Patent Application Publication
(10) Pub. No.: US 2018/0361287 A1
(43) Pub. Date: Dec. 20, 2018

(54) FILTER MEDIA INCLUDING A MULTI-PHASE PRE-FILTER

(71) Applicant: Hollingsworth & Vose Company, East Walpole, MA (US)

(72) Inventors: Xiaodan Zhang, Nashua, NH (US); Maxim Silin, Hudson, MA (US); Douglas M. Guimond, Pepperell, MA (US); David T. Healey, Bellingham, MA (US)

(73) Assignee: Hollingsworth & Vose Company, East Walpole, MA (US)

(21) Appl. No.: 15/651,006

(22) Filed: Jul. 17, 2017

Related U.S. Application Data
(60) Provisional application No. 62/520,949, filed on Jun. 16, 2017.

(51) Int. Cl. B01D 39/16

(52) U.S. Cl. CPC B01D 39/163; B01D 2239/0618; B01D 2239/065; B01D 2239/0216; B01D 2239/1258; B01D 2239/1275; B01D 2239/1233

(57) ABSTRACT

Filter media, as well as related components, systems, and methods, are described herein. In some embodiments, the filter media comprises one or more layers including, for example, a pre-filter layer and a main filter layer. The pre-filter layer may comprise a non-woven web (e.g., a wet-laid non-woven web). In some instances, the non-woven web comprises two or more phases. Each phase of the pre-filter layer may be characterized by a surface average fiber diameter (SAFD), and the SAFD may vary across at least a portion of the thickness of the pre-filter layer. The filter media may have improved dust-holding capacities for dust particles having a wide range of particle sizes, and/or improved mechanical strength (e.g., stiffness).

### RELATED APPLICATIONS

This application claims priority to U.S. Provisional Application No. 62/520,949, filed Jun. 16, 2017, which is incorporated herein by reference in its entirety.

### FIELD OF INVENTION

The present embodiments relate generally to filter media and, more specifically, to filter media comprising a multi-phase pre-filter.

### BACKGROUND

Filter elements can be used to remove contamination in a variety of applications. Depending on the application, the filter media may be designed to have different performance characteristics. For example, filter media may be designed to have performance characteristics suitable for HVAC applications that involve filtering contamination in air.

In general, filter media can be formed of a web of fibers. The fiber web provides a porous structure that permits fluid (e.g., air) to flow through the filter media. Contaminant particles (e.g., dust particles) contained within the fluid may be trapped on or in the fiber web. Filter media characteristics, such as fiber diameter and basis weight, can affect certain filter performance characteristics, such as dust-holding capacity.

There is a need for filter media that can be used for air filtration and that have desirable properties, including a high dust-holding capacity and high mechanical strength.

### SUMMARY OF THE INVENTION

Filter media comprising a multi-phase pre-filter, and related components, systems, and methods associated therewith, are provided.

In one set of embodiments, filter media are provided. In some embodiments, a filter media comprises a pre-filter layer. In certain embodiments, the pre-filter layer comprises a first phase comprising a first plurality of fibers. In some instances, the first phase has a surface average fiber diameter (SAFD) of greater than or equal to about 3 μm and less than or equal to about 30 μm. In certain embodiments, the pre-filter layer comprises a second phase comprising a second plurality of fibers. In some instances, the second phase has an SAFD of greater than or equal to about 0.5 μm and less than or equal to about 20 μm. In certain embodiments, a ratio of the SAFD of the first phase to the SAFD of the second phase is greater than or equal to about 1.2 and less than or equal to about 6. In certain embodiments, the pre-filter layer has a Gurley stiffness in the machine direction of greater than or equal to about 150 mg. In certain embodiments, the pre-filter layer has an air permeability of greater than about 80 CFM.

In another set of embodiments, a filter media comprises a pre-filter layer and a main filter layer. In certain embodiments, the pre-filter layer comprises a first phase comprising a first plurality of fibers. In some instances, the first phase has a surface average fiber diameter (SAFD) of greater than or equal to about 3 μm and less than or equal to about 30 μm. In certain embodiments, the pre-filter layer comprises a second phase comprising a second plurality of fibers. In some instances, the second phase has an SAFD of greater than or equal to about 0.5 μm and less than or equal to about 20 μm. In certain embodiments, a ratio of the SAFD of the first phase to the SAFD of the second phase is greater than or equal to about 1.2 and less than or equal to about 6. In certain embodiments, the main filter layer comprises a third plurality of fibers. In some instances, the main filter layer has an SAFD of less than the SAFD of the second phase of the pre-filter layer. In some instances, the main filter layer has an average fiber diameter of greater than or equal to 70 nm and less than or equal to 1 μm. In certain embodiments, a ratio of a thickness of the pre-filter to a thickness of the main filter layer is greater than or equal to 8.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic diagram of an exemplary pre-filter layer comprising a first phase and a second phase, according to some embodiments;

FIG. 1B shows a schematic diagram of an exemplary pre-filter layer comprising a first phase, a second phase, and an intermediate phase, according to some embodiments;

FIG. 2A shows, according to some embodiments, a schematic diagram of an exemplary filter media comprising a multi-phase pre-filter layer and a main filter layer;

FIG. 2B shows, according to some embodiments, a schematic diagram of an exemplary filter media comprising a multi-phase pre-filter layer, a main filter layer, and a protective layer;

FIG. 3A shows a plot of average fiber diameter as a function of normalized thickness, according to some embodiments;

FIG. 3B shows a schematic diagram of a pre-filter layer having a gradient in a property across the pre-filter layer according to the plot shown in FIG. 3A, according to some embodiments;

FIG. 4A shows, according to some embodiments, a plot of ASHRAE dust-holding capacity as a function of SAFD ratio;

FIG. 4B shows, according to some embodiments, a plot of ISO fine dust-holding capacity as a function of SAFD ratio;

FIG. 4C shows, according to some embodiments, a plot of pressure drop after NaCl loading as a function of tight phase SAFD; and

FIG. 5 shows a plot of average fiber diameter as a function of normalized thickness for different filter media, according to some embodiments.

### DETAILED DESCRIPTION

Filter media, as well as related components, systems, and methods, are described herein. In some embodiments, the filter media comprises one or more layers including, for example, a pre-filter layer and a main filter layer. The pre-filter layer may comprise a non-woven web (e.g., a wet-laid non-woven web). In some instances, the non-woven web comprises two or more phases. Each phase of the pre-filter layer may be characterized by a surface average fiber diameter (SAFD, described in more detail below), and the SAFD may vary across at least a portion of the thickness of the pre-filter layer. For example, a first phase at the top surface (e.g., most upstream location) of the pre-filter layer may have a larger SAFD than a second phase at the bottom surface (e.g., most downstream location) of the pre-filter layer. In some such embodiments, the multi-phase pre-filter layer may impart beneficial properties to the filter media. For example, certain multi-phase pre-filter layers described herein may result in filter media having improved performance properties, such as improved dust-holding capacities for dust particles having a wide range of particle sizes, and/or improved mechanical properties, such as improved mechanical strength (e.g., stiffness). Filter media described herein may be particularly well-suited for applications that involve filtering air, though the filter media may also be used in other applications.

Certain existing pre-filter layers, such as certain single-phase pre-filter layers and multi-phase pre-filter layers having uniform SAFD values, may have certain disadvantages that can render them less desirable for use in air filters. For example, filter media comprising certain existing pre-filter layers may only be capable of capturing dust particles within a narrow range of particle sizes. Given the wide range of dust particle sizes present in air, these filter media may be less desirable for use in air filters. In addition, certain existing pre-filter layers may have insufficient mechanical strength (e.g., stiffness) for pleating. In order to facilitate pleating, filter media comprising certain existing pre-filter layers may include an additional layer solely to impart mechanical strength. The presence of this additional layer can increase the cost and/or manufacturing complexity of the filter media.

Multi-phase pre-filter layers described herein may have certain beneficial performance properties. In some cases, for example, the phases of the pre-filter layer may have different characteristics and filtration properties that, when combined, may result in desirable overall filtration performance. In certain instances, the phases have SAFD values that vary across at least a portion of the thickness of the pre-filter layer such that an SAFD gradient is produced (e.g., a more upstream phase having a larger SAFD value than a more downstream phase). In some such instances, an upstream phase having a larger SAFD may be capable of trapping relatively larger particles, while a downstream phase having a smaller SAFD may be capable of trapping relatively smaller particles. In some embodiments, a filter media comprising a multi-phase pre-filter layer further comprises a main filter layer having a smaller SAFD than the most downstream phase of the pre-filter layer. In some such embodiments, a filter media comprising a multi-phase pre-filter layer having an SAFD gradient may, therefore, advantageously trap large amounts of dust particles in a wide range of particle sizes.

Multi-phase pre-filter layers described herein may also have certain beneficial mechanical properties. In some embodiments, for example, the pre-filter layer comprises a non-woven web (e.g., a wet-laid non-woven web). In some instances, the non-woven web is associated with mechanical strength (e.g., stiffness). This stiffness of the pre-filter layer may advantageously enhance pleatability of the filter media. In addition, in certain instances, the pre-filter layer comprises a relatively high weight percentage of synthetic fibers, which may impart durability and/or suitability for certain applications.

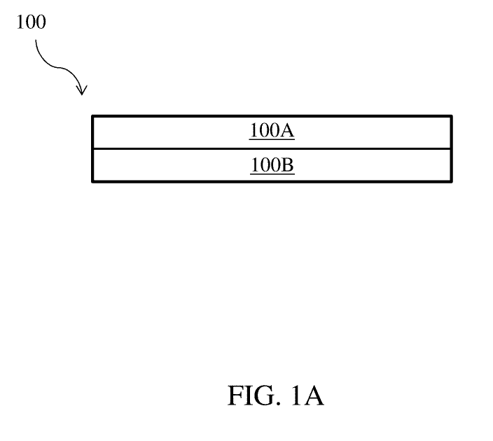

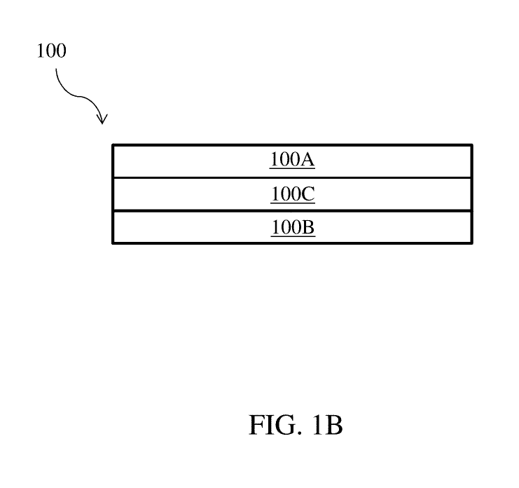

FIG. 1A shows a schematic diagram of exemplary pre-filter layer 100. In FIG. 1A, pre-filter layer 100 comprises first phase 100A comprising a first plurality of fibers and second phase 100B comprising a second plurality of fibers. First phase 100A may be positioned upstream of second phase 100B (e.g., in a filter element). It should be noted that the terms “upstream” and “downstream” are used herein to describe the relative arrangement of a phase with respect to the direction of flow of the fluid (e.g., air) to be filtered. An upstream phase comes into contact with the fluid to be filtered before a downstream phase. First phase 100A may be adjacent (e.g., directly or indirectly adjacent) to second phase 100B. A phase may be referred to as being “directly adjacent” to another phase when no intervening phase is present. In contrast, a phase may be referred to as being “indirectly adjacent” to another phase when one or more intervening phases are present.

The first plurality of fibers of first phase 100A and the second plurality of fibers of second phase 100B may comprise fibers with different characteristics (e.g., fiber diameters, fiber lengths) and may have different SAFDs. For example, first phase 100A may have a larger SAFD than second phase 100B. In some instances, first phase 100A may be referred to as a “coarse phase.” As used herein, the “coarse phase” refers to the phase having the largest SAFD of the phases of the pre-filter layer. In some embodiments, the coarse phase is the most upstream phase of pre-filter layer 100, although other configurations are also possible. In some instances, second phase 100B may be referred to as a “tight phase.” As used herein, the “tight phase” refers to the phase having the smallest SAFD of the phases of the pre-filter layer. In some embodiments, the tight phase is the most downstream phase of pre-filter layer 100, although other configurations are also possible.

In some embodiments, one or more intermediate phases may be positioned between first phase 100A and second phase 100B of pre-filter layer 100. For example, FIG. 1B shows a schematic diagram of exemplary pre-filter layer 100 comprising first phase 100A, second phase 100B, and third phase 100C positioned between first phase 100A and second phase 100B. In some embodiments, third phase 100C comprises at least a portion of the first plurality of fibers of first phase 100A and/or the second plurality of fibers of second phase 100B. In some cases, third phase 100C has an SAFD that is greater than or equal to the SAFD of second phase 100B and less than or equal to the SAFD of first phase 100A. First phase 100B, third phase 100C, and second phase 100B may therefore form pre-filter layer 100 having an SAFD gradient.

In certain instances, two or more intermediate phases are positioned between first phase 100A and second phase 100B. In some such instances, each intermediate phase has an SAFD that is greater than or equal to the SAFD of second phase 100B and less than or equal to the SAFD of first phase 100A. In some embodiments, each intermediate phase of pre-filter 100 has an SAFD that is greater than or equal to the SAFD of the immediately downstream phase and is less than or equal to the SAFD of the immediately upstream phase.

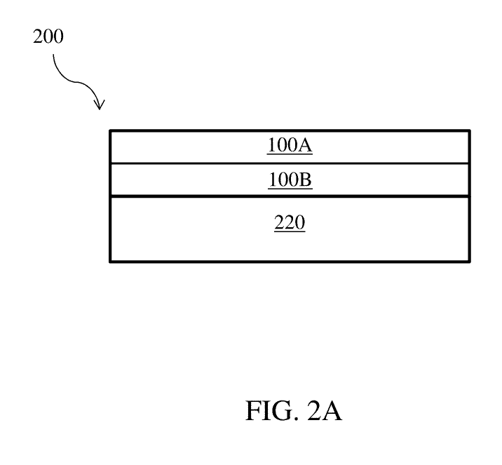

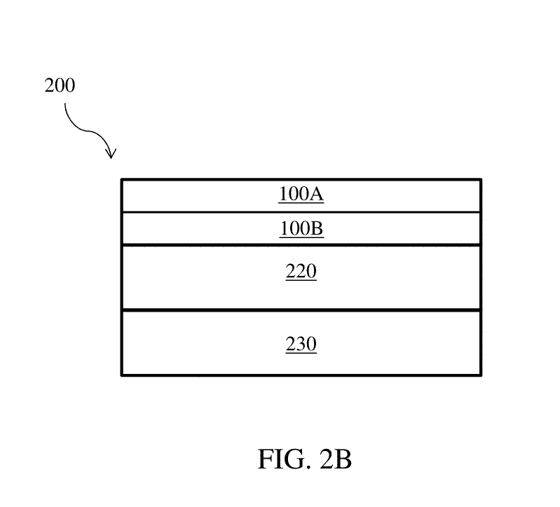

In some embodiments, a filter media comprises a multi-phase pre-filter layer and a main filter layer. FIG. 2A shows a schematic diagram of exemplary filter media 200. As shown in FIG. 2A, filter media 200 comprises pre-filter layer 100 and main filter layer 220. Pre-filter layer 100, which comprises first phase 100A comprising a first plurality of fibers and second phase 100B comprising a second plurality of fibers, may be positioned upstream of main filter layer 220 comprising a third plurality of fibers. In some embodiments, second phase 100B of pre-filter layer 100 is adjacent (e.g., directly or indirectly adjacent) to main filter layer 220. According to certain embodiments, main filter layer 220 has an SAFD that is less than or equal to the SAFD of second phase 100B of pre-filter layer 100.

In some embodiments, a filter media further comprises a protective layer. For example, FIG. 2B shows filter media 200 comprising pre-filter layer 100, which comprises first phase 100A comprising a first plurality of fibers and second phase 100B comprising a second plurality of fibers, main filter layer 220 comprising a third plurality of fibers, and protective layer 230 comprising a fourth plurality of fibers. In some embodiments, protective layer 230 is positioned downstream of main filter layer 220. As shown in FIG. 2B, in some embodiments, protective layer 230 is directly adjacent to main filter layer 220. In other embodiments, one or more intervening layers are positioned between main filter layer 220 and protective layer 230. According to certain embodiments, protective layer 230 has an SAFD that is greater than or equal to the SAFD of main filter layer 220.

Each layer of the filter media can have different characteristics and filtration properties. For example, the pre-filter layer, the main filter layer, and the protective layer can each comprise fibers having different characteristics (e.g., diameter, length). Fibers with different characteristics can be formed from one type of material (e.g., by using different process conditions) or from different types of material (e.g., different types of fibers). In certain embodiments, the pre-filter layer comprises a first phase and a second phase. In some cases, the second phase of the pre-filter layer comprises finer fibers than the first phase of the pre-filter layer. Accordingly, the second phase of the pre-filter layer may have a higher resistance to fluid flow than the first phase of the pre-filter layer. As such, the second phase of the pre-filter layer may be capable of trapping particles having a smaller size than the first phase of the pre-filter layer. In some cases, the main filter layer comprises even finer fibers than the second phase of the pre-filter layer. The main filter layer may, accordingly, be capable of trapping particles having an even smaller size than the second phase of the pre-filter layer. As described in further detail below, filter media comprising multi-phase pre-filters may advantageously trap particles (e.g., dust particles) having a wide ranges of particle sizes, which can improve the performance and lengthen the lifetime of the filter media.

As described above, in certain embodiments, the filter media comprises a pre-filter layer. In some cases, the pre-filter layer is the first layer encountered by fluid (e.g., air) flowing through the filter media. For this reason, it may be beneficial for the pre-filter layer to capture a large amount of the particles (e.g., dust particles) to which the filter media has been exposed and/or to have a high dust-holding capacity. In some cases, the multi-phase nature of the pre-filter layer may enable the filter media to be particularly effective in capturing dust having a wide range of particle sizes (e.g., coarse dust, fine dust).

In some embodiments, the pre-filter layer comprises a non-woven web. In general, a non-woven web includes non-oriented fibers (e.g., a random arrangement of fibers within the web). The non-woven web may, in some embodiments, comprise two or more phases. In some embodiments, one or more phases of the pre-filter layer (e.g., a first phase, a second phase, an intermediate phase) is/are layer(s) in which a clear demarcation between phases/layers is apparent. In certain instances, one or more phases of the pre-filter layer (e.g., a first phase, a second phase, an intermediate phase) comprise a region including intermingling of fibers between phases/layers. In some embodiments, a clear demarcation between two or more phases of the pre-filter layer is not apparent.

In some embodiments, the phases of the pre-filter layer are formed simultaneously (e.g., in a continuous process, such as a continuous wet-laid process), as described in more detail below. The pre-filter layer or non-woven web may, in some instances, be made by a wet-laid process. In other instances, the pre-filter layer or non-woven web is made by a non-wet-laid process. In some embodiments, the phases of the pre-filter layer are formed separately and then combined or joined (e.g., by adhesives, lamination, co-pleating, or collation).

In some cases, a characteristic (e.g., SAFD) of a phase of the pre-filter layer may be determined by measuring the characteristic at certain locations along the normalized thickness of the pre-filter layer. For example, a characteristic of the first phase of the pre-filter layer may be determined by measuring the characteristic at locations where the normalized thickness x (having a minimum value of 0 and a maximum value of 1) is greater than or equal to about 0 and less than or equal to about 0.35. In particular, the characteristic of the first phase of the pre-filter layer is determined by averaging the values measured at four locations within the above-described range: x=0.05, 0.15, 0.25, and 0.35.

In some embodiments, a characteristic (e.g., SAFD) of an intermediate phase of the pre-filter layer (if present) may be determined by measuring the characteristic at locations where the normalized thickness x is greater than or equal to about 0.45 and less than or equal to about 0.55. In particular, the characteristic of the intermediate phase of the pre-filter layer is determined by averaging the values measured at three locations within the above-described range: x=0.45, 0.5, and 0.55.

In some embodiments, a characteristic (e.g., SAFD) of a second phase of the pre-filter layer may be determined by measuring the characteristic at locations where the normalized thickness x is greater than or equal to about 0.65 and less than or equal to about 1. In particular, the characteristic of the second phase of the pre-filter layer is determined by averaging the values measured at four locations within the above-described range: x=0.65, 0.75, 0.85, and 0.95.

As used herein, the normalized thickness x refers to a dimensionless thickness that corresponds to a location along the thickness of the pre-filter layer. A normalized thickness value is calculated based on the thickness of the pre-filter layer. As an illustrative, non-limiting example, a pre-filter layer may start at a depth of 0 mm and end at a depth of 6 mm of the layer. The normalized thickness value at a given location along the thickness of the pre-filter layer may be calculated by subtracting the top surface (e.g., most upstream) location of the pre-filter layer from the given location and dividing by the bottom surface (e.g., most downstream) location minus the top surface (e.g., most upstream) location of the pre-filter layer. For example, in an exemplary embodiment in which the pre-filter extends from 0 mm to 6 mm and thus has a thickness of 6 mm, the normalized thickness x determined at a location of 3 mm is 0.5 (i.e., normalized thickness x=(3−0)/(6−0)). In general, the top surface (e.g., most upstream) location of the pre-filter layer has a normalized thickness of 0 and the bottom surface (e.g., most downstream) location of the pre-filter layer has a normalized thickness of 1.In some embodiments, at least a portion of the two or more phases of the pre-filter layer have different SAFD values. According to certain embodiments, for example, the first phase of the pre-filter layer (e.g., the most upstream phase of the pre-filter layer) has the largest SAFD. In some embodiments, the second phase of the pre-filter layer (e.g., the most downstream phase of the pre-filter layer) has the smallest SAFD.

Each phase of the pre-filter layer may independently comprise a plurality of fibers. In some embodiments, each plurality of fibers comprises one or more types of fibers, each fiber type having different fiber characteristics (e.g., average fiber diameters, fiber diameter distributions). In such cases, the average diameter of the fibers in a phase may be characterized using a weighted average, such as the surface average fiber diameter (SAFD).

The SAFD of a phase of the pre-filter layer (e.g., a first phase, a second phase, an intermediate phase) may be obtained via three methods. First, in embodiments in which the diameters, densities, and mass percentages of the fibers in a phase of the pre-filter layer are known, the SAFD of the phase can be calculated using the following equation:

d=Σ(mᵢ/ρᵢ)/Σ(mᵢ/dᵢρᵢ)

where d is the surface average fiber diameter in microns and mᵢ is the number fraction of the fibers with diameter dᵢ in microns and density ρᵢ in g/cm³. This equation assumes that the fibers are cylindrical, the fibers have a circular cross-section, and the fiber length is significantly greater than the diameter of the fibers. It should be understood that the equation also provides meaningful surface average fiber diameter values when a phase includes fibers that are substantially cylindrical and have a substantially circular cross-section.

Second, in some embodiments in which the pre-filter layer is already formed and the diameters, densities, and mass percentages of the fibers within a phase of the pre-filter layer are unknown, the pre-filter layer may be split at certain normalized thickness values corresponding to different phases (e.g., at x=0.35, 0.45, 0.55, and/or 0.65). The splitting may be performed using a sheet splitter (e.g., Beloit Sheet Splitter manufactured by Liberty Engineering Company, Roscoe, Ill.). Once the pre-filter layer is split, experimental methods such as optical microscopy and BET surface area measurements may be used to determine SAFD of a phase of the pre-filter layer (e.g., a first phase, a second phase, an intermediate phase).

In certain cases in which the pre-filter layer has been split, optical microscopy may be used to determine length Lᵢ and diameter Dᵢ of fibers within a phase of the pre-filter layer (e.g., a first phase, a second phase, an intermediate phase) according to TAPPI 401 (2003). The SAFD of the phase may be determined using the formula below:

$$SAFD = \frac{\sum {L}_{i}}{\sum ( \frac{{L}_{i}}{{D}_{i}} )}$$

This equation assumes that the measured fibers have a circular or substantially circular cross section.

Alternatively, in certain cases in which the pre-filter layer has been split, the surface average fiber diameter of a phase of the pre-filter layer (e.g., a first phase, a second phase, an intermediate phase) may be determined by measuring the BET specific surface area (“SSA”) and the density ρ of the phase. This method may be used for fibers having circular or non-circular cross sections.

In such cases, the surface average fiber diameter may be determined using the modified formula below:

$$SAFD [ μ m ] = 4 / ( SSA ρ [ in \frac{g}{{cm}^{3}} ] )$$

where SSA is the BET specific surface area of the phase in m²/g and ρ is the density of the phase in g/cm³. As used herein, the BET specific surface area is measured through use of a standard BET specific surface area measurement technique. In particular, the BET specific surface area is measured according to section 10 of Battery Council International Standard BCIS-03A, “Recommended Battery Materials Specifications Valve Regulated Recombinant Batteries,” section 10 being “Standard Test Method for Surface Area of Recombinant Battery Separator Mat.” Following this technique, the BET specific surface area is measured via adsorption analysis using a BET surface analyzer (e.g., Micromeritics Gemini III 2375 Surface Area Analyzer) with nitrogen gas. The sample amount is between 0.5 and 0.6 grams in, for example, a ¾″ tube, and the sample is allowed to degas at 75 degrees Celsius for a minimum of 3 hours. As used herein, the density of a phase may be determined by accurately measuring the mass and volume of the phase (e.g., excluding the void volume) and then calculating the density of the phase. The mass of the phase may be determined by weighing the phase. The volume of the phase may be determined using any known method of accurately measuring volume. For example, the volume may be determined using pycnometry. As another example, the volume of the phase may be determined using an Archimedes method provided that an accurate measurement of volume is produced. For example, the volume may be determined by fully submerging the phase in a wetting fluid and measuring the volume displacement of the wetting liquid as a result of fully submerging the phase.

Third, as yet another alternative, in some embodiments, the SAFD of a phase of the pre-filter layer (e.g., a first phase, a second phase, an intermediate phase) may be determined using X-ray computed tomography using suitable instrumentation (e.g., ZEISS Xradia 810 Ultra x-ray nano-tomograph manufactured by Carl Zeiss Microscopy GmbH 07745 Jena, Germany). In general, X-ray computed tomography is used to produce a 3D computational representation of the pre-filter layer. Computational methods are used to distinguish void spaces (i.e., pores) from solid regions (i.e., fibers) of the pre-filter layer. Additional computational methods may then be used to determine the average diameter of the solid regions (i.e., fibers) of the 3D computational representation of the pre-filter layer. Additional computational methods may be used to determine the surface area S and length L of each fiber. The equivalent surface average diameter D of each fiber (e.g., the diameter of the fiber with circular cross-section that has the same surface area as the actual fiber) can be computed using the following formula:

D=S/(πL)

The SAFD of the phase of the pre-filter layer may then be calculated according to the following formula:

$$SAFD = \frac{\sum {S}_{i}}{π \sum {L}_{i}}$$

where i refers to each individually measured fiber. This formula may be used for fibers of circular and non-circular cross sections.

The computational method may establish a cut-off value (i.e., threshold value) for distinguishing voids from solid regions to generate the 3D computational representation of the pre-filter layer. In such cases, the accuracy of the cut-off value may be confirmed by comparing the computationally determined air permeability of the 3D computational representation of the pre-filter layer to the experimentally determined air permeability of the actual pre-filter layer. In embodiments in which the computationally and experimentally determined air permeabilities are substantially different, the threshold value may be changed by the user until the air permeabilities are substantially the same.

For instance, in embodiments in which the diameter of the discrete fibers changes across at least a portion of the thickness of the pre-filter layer, an X-ray computed tomography (“CT”) machine may scan the pre-filter layer and take a plurality of X-ray radiographs at various projection angles through the pre-filter layer. Each X-ray radiograph may depict a slice along a plane of the pre-filter layer and may be converted into a grayscale image of the slice by computational methods known to those of skill in the art (e.g., ZEISS Xradia 810 Ultra x-ray nano-tomograph manufactured by Carl Zeiss Microscopy GmbH 07745 Jena, Germany). Each slice has a defined thickness such that the grayscale image of the slice is composed of voxels (volume elements), not pixels (picture elements). The plurality of slices generated from the X-ray radiographs may be used to produce a 3D volume rendering of the entire pre-filter layer thickness with cross-sectional dimensions of at least 100×100 μm using computational methods as noted above. The resolution (voxel size) of the image may be less than or equal to 0.3 microns.

In some embodiments, the 3D volume rendering of the entire pre-filter layer thickness, along with experimental measurements of the permeability of the filter media, may be used to determine the surface average fiber diameter. Each individual grayscale image generated from the X-ray radiographs typically consists of light intensity data scaled in an 8-bit range (i.e., 0-255 possible values). To form the 3D volume rendering of the entire filter media thickness, the 8-bit grayscale images are converted into binary images. The conversion of the 8-bit grayscale images to binary images requires the selection of an appropriate intensity threshold cut-off value to distinguish solid regions of the filter media from pore spaces in the filter media. The intensity threshold cut-off value is applied to the 8-bit grayscale image and is used to correctly segment solid and pore spaces in the binary image. The binary images are then used to create a virtual media domain, i.e., 3D rectangular array of filled (fiber) voxels and void (pore) voxels that accurately identifies solid regions and pore spaces. Various thresholding algorithms are reviewed in: Jain, A. (1989), Fundamentals of digital image processing, Englewood Cliffs, N.J.: Prentice Hall. and Russ. (2002), The image processing handbook, 4th ed. Boca Raton, Fla.: CRC Press.

The intensity threshold cut-off value may be selected based on comparison of the computationally determined air permeability of the virtual media domain in the transverse direction (i.e., the direction along the thickness) and experimentally determined air permeability of the entire pre-filter layer thickness in the transverse direction. In some such embodiments, the experimental air permeability of the entire pre-filter thickness may be determined according to TAPPI T-251 (1996), e.g., using a Textest FX 3300 air permeability tester III (Textest AG, Zurich), a sample area of 38 cm², and a pressure drop of 0.5 inches of water to obtain the Frazier permeability value of the entire pre-filter thickness in CFM. The Frazier permeability value in CFM is further converted to transverse media permeability in SI units according to the following conversion equation, where t₀ is thickness of the sample:

K [in m²]=7.47e−10*CFM [in feet/min or CFM/ft²]*t₀[in m]

The air permeability of the virtual media domain in the transverse direction may be computed using the computational fluid dynamics (CFD) solution of Navier-Stokes equation. A virtual media domain is generated by preselecting an intensity threshold cut-off value and converting the grayscale images into a virtual domain media using the preselected intensity threshold cut-off value. Once the virtual media domain is generated, numerical analysis can be performed directly on the virtual media domain using computational methods known to those of ordinary skill in the art. For example, the GeoDict 2010R2 software package can be used to directly convert grayscale images into the virtual media domain and to efficiently solve Stoke's equation,

−μ∇∇u+∇p=0, ∇u=0,

with no-slip boundary conditions in the pore space (see, e.g., Wiegmann, 2001-2010 GEODICT virtual micro structure simulator and material property predictor). The domain averaging of the resulting velocity field in the transverse direction, together with Darcy's equation,

<u>=−k∇p/μ,

allows determination of transverse air permeability k of virtual media.

The computational air permeability in the transverse direction is then compared to the experimental air permeability in the transverse direction. In embodiments in which the computational air permeability is substantially the same (e.g., a difference of 5% or less) as the experimental air permeability, then the virtual media domain generated using the preselected intensity threshold cut-off value is used to determine surface average fiber diameter. In embodiments in which the computational air permeability is different than the experimental air permeability, the intensity threshold cut-off value is changed until the computational air permeability is substantially the same as the experimental air permeability. The mean pore size of the virtual media domain that has substantially the same computational air permeability as the experimental air permeability can then be used to determine the average fiber diameter using any method known to those of ordinary skill in the art (e.g., PoroDict module of the GeoDict software package).

In some embodiments, the first phase (e.g., the coarse phase) of the pre-filter layer has a relatively large SAFD. In certain cases, the first phase of the pre-filter layer has an SAFD of greater than or equal to about 3 μm, greater than or equal to about 5 μm, greater than or equal to about 10 μm, greater than or equal to about 15 μm, greater than or equal to about 20 μm, greater than or equal to about 25 μm, or greater than or equal to about 30 μm. In some embodiments, the first phase of the pre-filter layer has an SAFD of less than or equal to about 30 μm, less than or equal to about 25 μm, less than or equal to about 20 μm, less than or equal to about 15 μm, less than or equal to about 10 μm, less than or equal to about 5 μm, or less than or equal to about 3 μm. All suitable combinations of the above-referenced ranges are also possible (e.g., greater than or equal to about 3 μm and less than or equal to about 30 μm, greater than or equal to about 5 μm and less than or equal to about 25 μm).

In some embodiments, the second phase (e.g., tight phase) of the pre-filter layer has an SAFD that is less than or equal to the SAFD of the first phase of the pre-filter layer. In certain cases, the second phase of the pre-filter layer has an SAFD of greater than or equal to about 0.5 μm, greater than or equal to about 1 μm, greater than or equal to about 5 μm, greater than or equal to about 10 μm, greater than or equal to about 15 μm, or greater than or equal to about 20 μm. In some embodiments, the second phase of the pre-filter layer has an SAFD of less than or equal to about 20 μm, less than or equal to about 15 μm, less than or equal to about 10 μm, less than or equal to about 5 μm, less than or equal to about 1 μm, or less than or equal to about 0.5 μm. All suitable combinations of the above-referenced ranges are also possible (e.g., greater than or equal to about 0.5 μm and less than or equal to about 20 μm, greater than or equal to about 1 μm and less than or equal to about 12 μm).

In some embodiments, the pre-filter layer comprises a third phase (e.g., intermediate phase) having an SAFD that is greater than or equal to the SAFD of the second phase (e.g., tight phase) and less than or equal to the SAFD of the first phase (e.g., coarse phase). In some embodiments, the third phase of the pre-filter layer has an SAFD of greater than or equal to about 1 μm, greater than or equal to about 2 μm, greater than or equal to about 5 μm, greater than or equal to about 10 μm, greater than or equal to about 15 μm, greater than or equal to about 20 μm, or greater than or equal to about 25 μm. In some embodiments, the third phase of the pre-filter layer has an SAFD of less than or equal to about 25 μm, less than or equal to about 20 μm, less than or equal to about 15 μm, less than or equal to about 10 μm, less than or equal to about 5 μm, less than or equal to about 2 μm, or less than or equal to about 1 μm. All suitable combinations of the above-referenced ranges are also possible (e.g., greater than or equal to about 1 μm and less than or equal to about 25 μm, greater than or equal to about 2 μm and less than or equal to about 25 μm).

In some embodiments, a ratio of the SAFD of the first phase of the pre-filter layer to the SAFD of the second phase of the pre-filter layer is relatively large. In some embodiments, the SAFD ratio is greater than or equal to about 1.0, greater than or equal to about 1.1, greater than or equal to about 1.2, greater than or equal to about 1.3, greater than or equal to about 1.4, greater than or equal to about 1.5, greater than or equal to about 1.6, greater than or equal to about 1.7, greater than or equal to about 1.8, greater than or equal to about 1.9, greater than or equal to about 2.0, greater than or equal to about 2.5, greater than or equal to about 3.0, greater than or equal to about 3.5, greater than or equal to about 4.0, greater than or equal to about 4.5, greater than or equal to about 5.0, greater than or equal to about 5.5, or greater than or equal to about 6.0. In some embodiments, the SAFD ratio is less than or equal to about 6.0, less than or equal to about 5.5, less than or equal to about 5.0, less than or equal to about 4.5, less than or equal to about 4.0, less than or equal to about 3.5, less than or equal to about 3.0, less than or equal to about 2.5, less than or equal to about 2.0, less than or equal to about 1.9, less than or equal to about 1.8, less than or equal to about 1.7, less than or equal to about 1.6, less than or equal to about 1.4, less than or equal to about 1.3, less than or equal to about 1.2, less than or equal to about 1.1, or less than or equal to about 1.0. All suitable combinations of the above-referenced ranges are also possible (e.g., greater than or equal to about 1.2 and less than or equal to about 6.0, greater than or equal to about 1.2 and less than or equal to about 1.8).

As noted above, the first phase of the pre-filter layer may comprise a first plurality of fibers, and the second phase of the pre-filter layer may comprise a second plurality of fibers. In certain embodiments, one or more intermediate phases comprising at least a portion of the first plurality of fibers and/or the second plurality of fibers are positioned between the first phase and the second phase of the pre-filter layer. In some instances, the first plurality of fibers and/or the second plurality of fibers comprise mono-component fibers. The mono-component fibers may comprise non-binder fibers and/or binder fibers. In some instances, the first plurality of fibers and/or the second plurality of fibers comprise multi-component (e.g., bi-component) fibers.

In some embodiments, the mono-component non-binder fibers (e.g., of the first plurality of fibers of the first phase and/or the second plurality of fibers of the second phase of the pre-filter layer) have an average fiber diameter of greater than or equal to about 1 μm, greater than or equal to about 2 μm, greater than or equal to about 5 μm, greater than or equal to about 10 μm, greater than or equal to about 15 μm, greater than or equal to about 20 μm, greater than or equal to about 25 μm, greater than or equal to about 30 μm, greater than or equal to about 35 μm, or greater than or equal to about 40 μm. In some instances, the mono-component non-binder fibers (e.g., of the first plurality of fibers and/or the second plurality of fibers) have an average fiber diameter of less than or equal to about 40 μm, less than or equal to about 35 μm, less than or equal to about 30 μm, less than or equal to about 25 μm, less than or equal to about 20 μm, less than or equal to about 15 μm, less than or equal to about 10 μm, less than or equal to about 5 μm, less than or equal to about 2 μm, or less than or equal to about 1 μm. All suitable combinations of the above-referenced ranges are also possible (e.g., greater than or equal to about 1 μm and less than or equal to about 20 μm, greater than or equal to about 1 μm and less than or equal to about 40 μm, greater than or equal to about 2 μm and less than or equal to about 25 μm). The average fiber diameter may be determined by using X-ray computed tomography (“CT”) using suitable instrumentation (e.g., ZEISS Xradia 810 Ultra x-ray nano-tomograph manufactured by Carl Zeiss Microscopy GmbH 07745 Jena, Germany). The average fiber diameter may also be determined by splitting the pre-filter layer into its component phases (e.g., splitting the pre-filter layer at locations where the normalized thickness x is 0.35, 0.45, 0.55, and 0.65) and using a scanning electron microscope (SEM) at a working distance of 13.6 mm-22.9 mm, with a magnification ranging between 2000×-5000× to measure fiber diameters. The pre-filter layer may be vacuum sputter coated with gold prior to image acquisition.

In some embodiments, the mono-component non-binder fibers (e.g., of the first plurality of fibers of the first phase and/or the second plurality of fibers of the second phase of the pre-filter layer) have an average length of greater than or equal to about 1 mm, greater than or equal to about 1.5 mm, greater than or equal to about 5 mm, greater than or equal to about 10 mm, greater than or equal to about 12 mm, greater than or equal to about 15 mm, or greater than or equal to about 18 mm. In some embodiments, the mono-component non-binder fibers (e.g., of the first plurality of fibers and/or the second plurality of fibers) have an average fiber length of less than or equal to about 18 mm, less than or equal to about 15 mm, less than or equal to about 12 mm, less than or equal to about 10 mm, less than or equal to about 5 mm, less than or equal to about 1.5 mm, or less than or equal to about 1 mm. All suitable combinations of the above-referenced ranges are also possible (e.g., greater than or equal to about 1 mm and less than or equal to about 18 mm, greater than or equal to about 1.5 mm and less than or equal to about 12 mm).

In certain embodiments, the weight percentage of a mono-component non-binder fiber in at least one phase of the pre-filter layer (e.g., a first phase, a second phase, an intermediate phase) or the entire pre-filter layer is greater than or equal to about 10 wt %, greater than or equal to about 20 wt %, greater than or equal to about 30 wt %, greater than or equal to about 40 wt %, greater than or equal to about 50 wt %, greater than or equal to about 60 wt %, greater than or equal to about 70 wt %, greater than or equal to about 80 wt %, greater than or equal to about 90 wt %, or greater than or equal to about 95 wt % with respect to the total weight of the at least one phase or the entire pre-filter layer. In some embodiments, the weight percentage of a mono-component non-binder fiber in at least one phase of the pre-filter layer (e.g., a first phase, a second phase, an intermediate phase) or the entire pre-filter layer is less than or equal to about 95 wt %, less than or equal to about 90 wt %, less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10 wt % with respect to the total weight of the at least one phase or the entire pre-filter layer. All suitable combinations of the above-referenced ranges are also possible (e.g., greater than or equal to about 10 wt % and less than or equal to about 95 wt %, greater than or equal to about 20 wt % and less than or equal to about 95 wt %).

In some embodiments, the mono-component binder fibers (e.g., of the first plurality of fibers of the first phase and/or the second plurality of fibers of the second phase of the pre-filter layer) have an average fiber diameter of greater than or equal to about 1 μm, greater than or equal to about 5 μm, greater than or equal to about 10 μm, greater than or equal to about 15 μm, greater than or equal to about 20 μm, greater than or equal to about 25 μm, greater than or equal to about 30 μm, greater than or equal to about 35 μm, or greater than or equal to about 40 μm. In some embodiments, the mono-component binder fibers (e.g., of the first plurality of fibers and/or the second plurality of fibers) have an average fiber diameter of less than or equal to about 40 μm, less than or equal to about 35 μm, less than or equal to about 30 μm, less than or equal to about 25 μm, less than or equal to about 20 μm, less than or equal to about 15 μm, less than or equal to about 10 μm, less than or equal to about 5 μm, or less than or equal to about 1 μm. All suitable combinations of the above-referenced ranges are also possible (e.g., greater than or equal to about 1 μm and less than or equal to about 40 μm, greater than or equal to about 1 μm and less than or equal to about 20 μm).

In some embodiments, the mono-component binder fibers (e.g., of the first plurality of fibers of the first phase and/or the second plurality of fibers of the second phase of the pre-filter layer) have an average fiber length of greater than or equal to about 1 mm, greater than or equal to about 1.5 mm, greater than or equal to about 5 mm, greater than or equal to about 10 mm, greater than or equal to about 12 mm, greater than or equal to about 15 mm, or greater than or equal to about 18 mm. In some embodiments, the mono-component binder fibers (e.g., of the first plurality of fibers and/or the second plurality of fibers) have an average fiber length of less than or equal to about 18 mm, less than or equal to about 15 mm, less than or equal to about 12 mm, less than or equal to about 10 mm, less than or equal to about 5 mm, less than or equal to about 1.5 mm, or less than or equal to about 1 mm. All suitable combinations of the above-referenced ranges are also possible (e.g., greater than or equal to about 1 mm and less than or equal to about 18 mm, greater than or equal to about 1.5 mm and less than or equal to about 12 mm).

In some embodiments, the weight percentage of a mono-component binder fiber in at least one phase of the pre-filter layer (e.g., a first phase, a second phase, an intermediate phase) or the entire pre-filter layer is greater than or equal to about 1 wt %, greater than or equal to about 2 wt %, greater than or equal to about 3 wt %, greater than or equal to about 4 wt %, greater than or equal to about 5 wt %, greater than or equal to about 6 wt %, greater than or equal to about 7 wt %, greater than or equal to about 8 wt %, greater than or equal to about 9 wt %, greater than or equal to about 10 wt %, greater than or equal to about 15 wt %, or greater than or equal to about 20 wt % with respect to the total weight of the at least one phase or the entire pre-filter layer. In some embodiments, the weight percentage of a mono-component binder fiber in at least one phase of the pre-filter layer (e.g., a first phase, a second phase, an intermediate phase) or the entire pre-filter layer is less than or equal to about 20 wt %, less than or equal to about 15 wt %, less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, less than or equal to about 2 wt %, or less than or equal to about 1 wt % with respect to the total weight of the at least one phase or the entire pre-filter layer. All suitable combinations of the above-referenced ranges are also possible (e.g., greater than or equal to about 1% and less than or equal to about 20%, greater than or equal to about 1% and less than or equal to about 8%).

In some embodiments, the multi-component fibers (e.g., of the first plurality of fibers of the first phase and/or the second plurality of fibers of the second phase of the pre-filter layer) have an average fiber diameter of greater than or equal to about 1 μm, greater than or equal to about 5 μm, greater than or equal to about 10 μm, greater than or equal to about 15 μm, greater than or equal to about 20 μm, greater than or equal to about 25 μm, greater than or equal to about 30 μm, greater than or equal to about 35 μm, or greater than or equal to about 40 μm. In some embodiments, the multi-component fibers (e.g., of the first plurality of fibers and/or the second plurality of fibers) have an average fiber diameter of less than or equal to about 40 μm, less than or equal to about 35 μm, less than or equal to about 30 μm, less than or equal to about 25 μm, less than or equal to about 20 μm, less than or equal to about 15 μm, less than or equal to about 10 μm, less than or equal to about 5 μm, or less than or equal to about 1 μm. All suitable combinations of the above-referenced ranges are also possible (e.g., greater than or equal to about 1 μm and less than or equal to about 40 μm, greater than or equal to about 1 μm and less than or equal to about 20 μm).

In some embodiments, the multi-component fibers (e.g., of the first plurality of fibers of the first phase and/or the second plurality of fibers of the second phase of the pre-filter layer) have an average fiber length of greater than or equal to about 1 mm, greater than or equal to about 1.5 mm, greater than or equal to about 5 mm, greater than or equal to about 10 mm, greater than or equal to about 12 mm, greater than or equal to about 15 mm, or greater than or equal to about 18 mm. In some embodiments, the multi-component binder fibers (e.g., of the first plurality of fibers and/or the second plurality of fibers) have an average fiber length of less than or equal to about 18 mm, less than or equal to about 15 mm, less than or equal to about 12 mm, less than or equal to about 10 mm, less than or equal to about 5 mm, less than or equal to about 1.5 mm, or less than or equal to about 1 mm. All suitable combinations of the above-referenced ranges are also possible (e.g., greater than or equal to about 1 mm and less than or equal to about 18 mm, greater than or equal to about 1.5 mm and less than or equal to about 12 mm).

In some embodiments, the weight percentage of a multi-component fiber in at least one phase of the pre-filter layer (e.g., a first phase, a second phase, an intermediate phase) or the entire pre-filter layer is greater than or equal to about 1 wt %, greater than or equal to about 2 wt %, greater than or equal to about 3 wt %, greater than or equal to about 4 wt %, greater than or equal to about 5 wt %, greater than or equal to about 10 wt %, greater than or equal to about 15 wt %, or greater than or equal to about 20 wt % with respect to the total weight of the at least one phase or the entire pre-filter layer. In some embodiments, the weight percentage of a multi-component fiber in at least one phase of the pre-filter layer (e.g., a first phase, a second phase, an intermediate phase) or the entire pre-filter layer is less than or equal to about 20 wt %, less than or equal to about 15 wt %, less than or equal to about 10 wt %, less than or equal to about 5 wt %, less than or equal to about 4 wt %, less than or equal to about 3 wt %, less than or equal to about 2 wt %, or less than or equal to about 1 wt % with respect to the total weight of the at least one phase or the entire pre-filter layer. All suitable combinations of the above-referenced ranges are also possible (e.g., greater than or equal to about 1 wt % and less than or equal to about 20 wt %, greater than or equal to about 3 wt % and less than or equal to about 10 wt %).

According to certain embodiments, at least one phase of the pre-filter layer (e.g., a first phase, a second phase, an intermediate phase) may comprise synthetic fibers which are fine staple fibers. For example, the fine staple fibers may comprise one or more of poly(ethylene terephthalate) (PET), nylon, poly(lactic acid), polyesters, and copolyesters. In some embodiments, the fine staple fibers may comprise modified poly(ethylene terephthalate) (PET) fibers, such as Cyphrex™ fibers manufactured by Eastman Chemical Company. In some embodiments, the fine staple fibers may comprise bi-component fibers, such as splitting fibers. In certain embodiments, the fine staple fibers may comprise other types of splitting fibers, in addition to bi-component splitting fibers, such as splitting fibers which can be split by mechanical or chemical means.

The fine staple fibers may have any suitable diameter. In some embodiments, the average diameter of the fine staple fibers in at least one phase of the pre-filter layer (e.g., a first phase, a second phase, an intermediate phase) or the entire pre-filter layer is greater than or equal to about 1 micron, greater than or equal to about 1.5 microns, greater than or equal to about 2 microns, greater than or equal to about 2.5 microns, greater than or equal to about 3 microns, greater than or equal to about 3.5 microns, greater than or equal to about 4 microns, greater than or equal to about 4.5 microns, or greater than or equal to about 5 microns. In some embodiments, the average diameter of the fine staple fibers in at least one phase of the pre-filter layer (e.g., a first phase, a second phase, an intermediate phase) or the entire pre-filter layer is less than or equal to about 5 microns, less than or equal to about 4.5 microns, less than or equal to about 4 microns, less than or equal to about 3.5 microns, less than or equal to about 3 microns, less than or equal to about 2.5 microns, less than or equal to about 2 microns, less than or equal to about 1.5 microns, or less than or equal to about 1 micron. All suitable combinations of the above-referenced ranges are also possible (e.g., greater than or equal to about 1 micron and less than or equal to about 5 microns, greater than or equal to about 2 microns and less than or equal to about 5 microns).

In some embodiments, at least one phase of the pre-filter layer (e.g., a first phase, a second phase, an intermediate phase) or the entire pre-filter layer may comprise a defined percentage of fine staple fibers. In some embodiments, the weight percentage of fine staple fibers in at least one layer of the pre-filter layer (e.g., a first phase, a second phase, an intermediate phase) or the entire pre-filter layer is greater than or equal to about 2.5 wt %, greater than or equal to about 8 wt %, greater than or equal to about 10 wt %, greater than or equal to about 12 wt %, greater than or equal to about 14 wt %, greater than or equal to about 16 wt %, greater than or equal to about 18 wt %, greater than or equal to about 20 wt %, greater than or equal to about 30 wt %, or greater than or equal to about 40 wt % with respect to the total weight of the at least one phase or the entire pre-filter layer. In some embodiments, the weight percentage of fine staple fibers in at least one layer of the pre-filter layer (e.g., a first phase, a second phase, an intermediate phase) or the entire pre-filter layer is less than or equal to about 40 wt %, less than or equal to about 30 wt %, less than or equal to about 20 wt %, less than or equal to about 18 wt %, less than or equal to about 16 wt %, less than or equal to about 14 wt %, less than or equal to about 12 wt %, less than or equal to about 10 wt %, less than or equal to about 8 wt %, or less than or equal to about 2.5 wt % with respect to the total weight of the at least one phase or the entire pre-filter layer. All suitable combinations of the above-referenced ranges are also possible (e.g., at least 8 wt % and less than 20 wt % of the synthetic fibers in the pre-filter layer may be fine staple fibers).

In some embodiments, the weight percentage of fibers in at least one phase of the pre-filter layer (e.g., a first phase, a second phase, an intermediate phase) having an average fiber diameter greater than or equal to about 10 μm, greater than or equal to about 20 μm, greater than or equal to about 30 μm, or greater than or equal to about 40 μm, is greater than or equal to about 5 wt %, greater than or equal to about 10 wt %, greater than or equal to about 20 wt %, greater than or equal to about 50 wt %, or greater than or equal to about 95 wt % with respect to the total weight of the at least one phase.

In some embodiments, the total weight percentage of fibers in at least one phase of the pre-filter layer (e.g., a first phase, a second phase, an intermediate phase) includes two or more populations of fibers having different average fiber diameters. For example, in certain embodiments, a blend of fibers having different diameters may be used to help achieve a desired SAFD. In general, any suitable number of fiber populations having different average fiber diameters may be used. In certain other embodiments, the total weight percentage of fibers in at least one phase of the pre-filter layer (e.g., a first phase, a second phase, an intermediate phase) is composed of one fiber population. That is, in certain embodiments, at least one phase of the pre-filter layer (e.g., a first phase, a second phase, an intermediate phase) does not comprise two or more populations of fibers having different average fiber diameters.

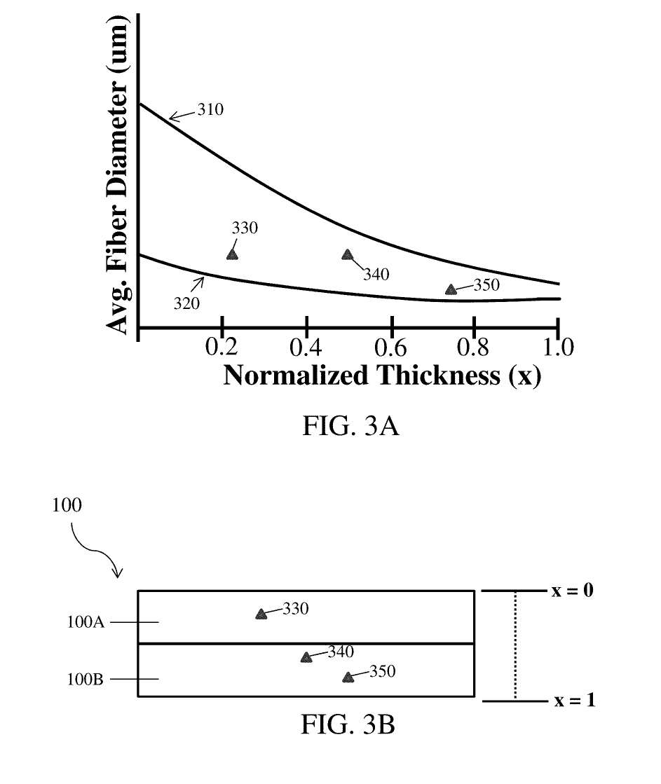

As noted above, there may be a gradient in SAFD across the thickness of the pre-filter layer. In some embodiments, there may also be a gradient in average fiber diameter across the thickness of the pre-filter layer. In some embodiments, a relationship may exist between average fiber diameter and the thickness of the pre-filter layer, such that the gradient in average fiber diameter may be characterized by two mathematical functions (e.g., convex functions), as schematically illustrated in FIG. 3A. FIG. 3A shows plots of a first mathematical function 310 and a second mathematical function 320 on a graph. The y-axis of the graph is average fiber diameter, and the x-axis of the graph is the normalized thickness of the portion of the pre-filter layer having the gradient, such that zero corresponds to the top surface (e.g., most upstream) location of the gradient and one corresponds to the bottom surface (e.g., most downstream) location of the gradient. The first mathematical function may be different from the second mathematical function. In some such embodiments, the first mathematical function may have a greater average fiber diameter for any given normalized thickness compared to the second mathematical function. In such cases, the first mathematical function may serve as an upper limit for the average fiber diameter at a given normalized thickness. The second mathematical function may serve as the lower limit for the average fiber diameter at that normalized thickness.

Accordingly, in some embodiments, at least some of the average fiber diameters (e.g., all of the average fiber diameters) within the gradient may fall within the area 330 defined by the first and second mathematical functions. That is, in some embodiments, to produce a gradient, e.g., in fiber diameter that imparts beneficial properties (e.g., low pressure drop, long service life) to the filter media, the average fiber diameter at certain locations (e.g., three or more locations, four or more locations, five or more locations, six or more locations, substantially all locations, all locations), along the thickness of the gradient must fall within area 330 defined by mathematical functions 310 and 320, as described in more detail below.

In some embodiments, the mathematical functions are exponential functions. For instance, the first mathematical equation may have the form:

$$f ( x ) = \frac{{B}_{max}}{{( exp ( {A}_{min} * x ) )}^{2}}$$

wherein f(x) is the average fiber diameter at x, x is the normalized thickness of the gradient, Bₘₐₓ is a constant with micron units, and Aₘᵢₙ is a constant. The average fiber diameter may be determined by using scanning electron microscopy (“SEM”) or X-ray computed tomography (“CT”), as described in more detail below. In some such embodiments, the second mathematical equation may have the form:

$$f ( x ) = \frac{{B}_{min}}{{( exp ( {A}_{max} * x ) )}^{2}}$$

wherein f(x) is the average fiber diameter at x, x is the normalized thickness of the gradient, Bₘᵢₙ is a constant with micron units, and Aₘₐₓ is a constant. In some such embodiments, the average fiber diameter, f(x), at one or more locations along thickness of the gradient may be determined using the mathematical expression:

$$\frac{{B}_{min}}{{( exp ( {A}_{max} * x ) )}^{2}} \leq f ( x ) \leq \frac{{B}_{max}}{{( exp ( {A}_{min} * x ) )}^{2}}$$

wherein f(x) is the average fiber diameter at x, x is the normalized thickness of the gradient, Bₘₐₓ is a constant with micron units, Bₘᵢₙ is a constant with micron units, Aₘₐₓ is a constant, and Aₘᵢₙ is a constant. Thus, in some embodiments, the first mathematical function serves as an upper limit for the average fiber diameter at a given normalized thickness, and the second mathematical function serves as a lower limit for the average fiber diameter at the same normalized thickness.

Without being bound by theory, a gradient in fiber diameter having average fiber diameters that primarily fall above the first mathematical function may produce a pre-filter layer that has a substantially diminished ability to trap particles. Conversely, a gradient in fiber diameters having average fiber diameters that primarily fall below the second mathematical function may produce a pre-filter layer having a relatively high initial pressure drop. In some embodiments, a high pressure drop can reduce the service life of the filter media. The area between the two mathematical functions can be used to systemically design filter media having a desirable pressure drop, change in pressure drop over time, efficiency, and/or service life, amongst other beneficial properties.

It should be understood that not all of the average fiber diameters along the thickness of the pre-filter layer must fall within the area between the two mathematical functions to produce a gradient that imparts beneficial properties to the filter media. In general, such a gradient may be produced when most (e.g., greater than or equal to about 70%, greater than or equal to about 75%, greater than or equal to about 80%, greater than or equal to about 90%, greater than or equal to about 95%) of the average fiber diameters along the thickness of the pre-filter layer fall within the area between the mathematical functions. In some embodiments, the percentage of average fiber diameters along the thickness of the pre-filter layer that fall between the two mathematical functions is greater than or equal to about 70%, greater than or equal to about 75%, greater than or equal to about 80%, greater than or equal to about 85%, greater than or equal to about 90%, greater than or equal to about 95%, or about 100%. In some embodiments, the percentage of average fiber diameters along the thickness of the pre-filter layer that fall between the two mathematical functions is less than or equal to about 100%, less than or equal to about 95%, less than or equal to about 90%, less than or equal to about 85%, less than or equal to 80%, less than or equal to about 75%, or less than or equal to about 70%. All suitable combinations of the above-referenced ranges are also possible (e.g., greater than or equal to about 70% and less than or equal to about 100%, greater than or equal to about 85% and less than or equal to about 100%).

It should be understood that the two or more locations along the thickness of the pre-filter layer may be at any suitable normalized thickness x. For instance, the two or more locations may be at x equals 0, about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, and/or 1. All suitable combinations of the above-referenced locations are possible (e.g., x equals about 0.25, about 0.5, and about 0.75). It should be also understood that the one or more locations along the thickness of the pre-filter layer may be at any suitable location. For instance, the one or more locations may be at the top surface, quarter thickness, half thickness, three-quarters thickness, and/or bottom surface locations. All suitable combinations of the above-referenced locations are possible (e.g., top surface and bottom surface).

In one example, as illustrated in FIG. 3B, pre-filter 100 comprises first phase 100A positioned adjacent to (e.g., upstream) of second phase 100B. First phase 100A and second phase 100B may form a gradient in fiber diameter. As shown in FIG. 3B, pre-filter layer 100 may have average fiber diameters at three or more locations (e.g., 330, 340, 350) along the thickness of the pre-filter layer. The average fiber diameters 330, 340, and 350 may be greater than or equal to second mathematical function 320, which may have the following form:

$$f ( x ) = \frac{{B}_{min}}{{( exp ( {A}_{max} * x ) )}^{2}}$$

The average fiber diameters 330, 340, and 350 may also be less than or equal to first mathematical function 310, which may have the following form:

$$f ( x ) = \frac{{B}_{max}}{{( exp ( {A}_{min} * x ) )}^{2}}$$

In some embodiments, the constants Bₘₐₓ and Bₘᵢₙ may be related to certain structural properties of the pre-filter layer. In certain embodiments, Bₘₐₓ is related to the maximum suitable average fiber diameter at the top surface (e.g., most upstream) location (e.g., x=0) of the gradient portion of the pre-filter layer. In some embodiments, the value of Bₘₐₓ may be less than or equal to about 30 μm, less than or equal to about 28 μm, less than or equal to about 26 μm, less than or equal to about 25 μm, less than or equal to about 24 μm, less than or equal to about 22 μm, less than or equal to about 20 μm, less than or equal to about 18 μm, less than or equal to about 16 μm, less than or equal to about 15 μm, less than or equal to about 14 μm, less than or equal to about 12 μm, less than or equal to about 10 μm, less than or equal to about 6.5 μm, less than or equal to about 5 μm, or less than or equal to about 3 μm. It should be understood that Bₘₐₓ may be any individual value within the above-referenced ranges. In certain embodiments, Bₘₐₓ is less than or equal to about 30 μm (e.g., less than or equal to about 20 μm).

Conversely, in certain embodiments, Bₘᵢₙ is related to the minimum suitable average fiber diameter at the top surface (e.g., most upstream) location (e.g., x=0) of the gradient portion of the pre-filter layer. In some embodiments, the value of Bₘᵢₙ may be greater than or equal to about 3 μm, greater than or equal to about 3.5 μm, greater than or equal to about 4 μm, greater than or equal to about 4.5 μm, greater than or equal to about 5 μm, greater than or equal to about 5.5 μm, greater than or equal to about 6 μm, or greater than or equal to about 6.5 μm. It should be understood that Bₘᵢₙ may be any individual value within the above-referenced ranges.

In some embodiments, the constants Aₘₐₓ and Aₘᵢₙ may be related to the change in average fiber diameter across the gradient portion of the pre-filter layer. Without being bound by theory, a gradual decrease in average fiber diameter as described by parameter A may contribute to the attainment of a depth loading filtration mechanism and prevents surface loading. In certain embodiments, Aₘₐₓ is related to the maximum change in average fiber diameter that prevents dust cake formation, and accordingly surface filtration, on the downstream portion of the filter media. In some embodiments, Aₘᵢₙ is related to the minimum change in average fiber diameter across the gradient portion of the filter media in which a depth filtration mechanism, and not surface filtration, dominates on the upstream portion of the filter media. Aₘᵢₙ equals zero corresponds to a pre-filter layer without a gradient portion.

In certain embodiments, gradients in fiber diameter characterized by exponential functions with certain values of Aₘₐₓ and Aₘᵢₙ may have enhanced filtration properties (e.g., low initial pressure drop, low increase in pressure drop over time) compared to pre-filter layers lacking a gradient or pre-filter layers having a gradient characterized by exponential functions with other values of Aₘₐₓ and Aₘᵢₙ. For instance, in some embodiments, in which the gradient is along substantially all of the thickness of the pre-filter layer, enhanced filtration properties may be achieved with values of Aₘₐₓ of less than or equal to 1.2, less than or equal to about 1.1, less than or equal to about 1.0, less than or equal to about 0.9, less than or equal to about 0.8, less than or equal to about 0.7, less than or equal to about 0.6, less than or equal to about 0.5, less than or equal to about 0.4, less than or equal to about 0.3, or less than or equal to about 0.2. It should be understood that Aₘₐₓ may be any individual value within the above-referenced ranges.

In some embodiments, enhanced filtration properties may be achieved with values of Aₘᵢₙ greater than or equal to about 0.2, greater than or equal to about 0.3, greater than or equal to about 0.4, greater than or equal to about 0.5, greater than or equal to about 0.6, greater than or equal to about 0.7, greater than or equal to about 0.8, greater than or equal to about 0.9, greater than or equal to about 1.0, or greater than or equal to about 1.1. It should be understood that Aₘᵢₙ may be any individual value within the above-referenced ranges.

In general, the average fiber diameter, f(x), at a specific location within the pre-filter layer may be determined using any technique known to those of ordinary skill in the art to produce accurate measurements of average fiber diameter. For instance, the average fiber diameter at one or more surfaces (e.g., top surface and/or bottom surface, the most upstream and/or most downstream location) of a fiber web or the pre-filter layer may be determined using scanning electron microscopy (SEM). In some embodiments, the average fiber diameter at a location may be determined by measuring fiber diameters using a scanning electron microscope SEM at a working distance of 13.6 mm-22.9 mm, with a magnification ranging between 2000×-5000×. The filter media or pre-filter layer may be vacuum sputter coated with gold prior to image acquisition. In some embodiments, the average fiber diameter at a location may be determined using X-ray computed tomography, as described above.

It should be understood that though a pre-filter layer having a gradient in a property has been described in terms of a gradient in average fiber diameter, the pre-filter layer may have a gradient in another property (e.g., mean flow pore size, solidity) instead of, or in addition to, a gradient in average fiber diameter. For instance, in some embodiments, a pre-filter layer having a gradient in average fiber diameter across at least a portion of the thickness of the pre-filter layer may have a gradient in mean flow pore size and/or a gradient in solidity. In general, the pre-filter layer may have a gradient in any property or combinations of properties that are capable of achieving the desired filtration properties.

As described herein, a pre-filter layer may have a gradient in average fiber diameter across at least a portion of the thickness of the pre-filter layer. In some embodiments, the gradient in average fiber diameter may be across the entire pre-filter layer. In some such embodiments, the pre-filter layer may be a single fiber web or have multiple fiber webs (e.g., multiple layers) that form the gradient. In other embodiments, the gradient in average fiber diameter may be across a portion, but not all, of the pre-filter layer.

In some embodiments, the gradient in average fiber diameter may be across at least a portion of the thickness of the pre-filter layer or the entire thickness of the pre-filter layer. For instance, in some embodiments, the gradient in average fiber diameter may be across greater than or equal to about 10%, greater than or equal to about 20%, greater than equal to about 30%, greater than or equal to about 40%, greater than or equal to about 50%, greater than or equal to about 60%, greater than equal to about 70%, greater than or equal to about 80%, or greater than or equal to about 90% of the thickness of the pre-filter layer. In some instances, the gradient in average fiber diameter may be across less than or equal to about 100%, less than or equal to about 99%, less than or equal to about 97%, less than or equal to about 95%, less than equal to about 90%, less than or equal to about 80%, less than or equal to about 70%, less than or equal to about 60%, less than or equal to about 50%, less than or equal to about 40%, less than or equal to about 30%, less than or equal to about 20%, or less than or equal to about 10% of the thickness of the pre-filter layer. All suitable combinations of the above-referenced ranges are also possible (e.g., greater than or equal to about 10% and less than or equal to about 100%, greater than or equal to about 40% and less than or equal to about 100%). Other values are possible. The percentage of the total thickness of the pre-filter layer occupied by the gradient in average fiber diameter may be determined by dividing the thickness of the gradient portion by the thickness of the pre-filter layer.

In some embodiments, at least one phase of the pre-filter layer (e.g., a first phase, a second phase, an intermediate phase) comprises mono-component fibers. The mono-component fibers may include any suitable fiber type. In some embodiments, at least a portion of the mono-component fibers are synthetic fibers. In general, synthetic fibers may include any suitable type of synthetic polymer. In some embodiments, the synthetic polymer comprises one or more thermoplastic polymers. Non-limiting examples of suitable thermoplastic polymers include polyesters (e.g., poly(butylene terephthalate), poly(butylene naphthalate), poly(ethylene terephthalate)), polyolefins (e.g., polyethylene, polypropylene), polyamides (e.g., various nylon polymers), polyaramids, polyalkylenes, polyacrylonitriles, polyphenylene sulfides, polycarbonates, thermoplastic polyurethanes, polystyrene, and combinations thereof. In certain embodiments, the synthetic fibers comprise modified cellulosic fibers (e.g., modified cellulosic staple fibers, synthetic cellulose such as lyocell, rayon). The synthetic fibers may also comprise a blend where at least one component comprises a thermoplastic polymer and/or modified cellulose.

In some embodiments, at least one phase of the pre-filter layer (e.g., a first phase, a second phase, an intermediate phase) comprises multi-component (e.g., bi-component) fibers. In certain embodiments, one or more components of the multi-component fibers comprise a polyester, a co-polyester, a polyolefin, and/or modified cellulose fibers. In certain embodiments, one or more components of the multi-component fibers comprise polyester and/or polyolefin fibers. In some embodiments, the multi-component (e.g., bi-component) fibers comprise side-by-side, core-sheath, eccentric core-sheath, islands in a sea, splittable pie, and/or hollow-center pie fibers. Each component of a multi-component fiber can have a different melting temperature. For example, the fibers can include a core and a sheath where the activation temperature of the sheath is lower than the melting temperature of the core. This allows the sheath to melt prior to the core, such that the sheath binds to other fibers in the layer, while the core maintains its structural integrity. This is particularly advantageous in that it creates a more cohesive layer for trapping filtrate. The core/sheath fibers can be concentric or non-concentric, and exemplary core/sheath fibers can include the following: a polyester core/copolyester sheath, a polyester core/polyethylene sheath, a polyester core/polypropylene sheath, a polypropylene core/polyethylene sheath, and combinations thereof. In some embodiments, the multi-component fibers are splitting fibers, which comprise a sheath that is capable of melting away to reveal a core with a smaller diameter. Such fibers may be capable of forming fine fibers with large surface areas after the sheath has melted. Other exemplary multi-component fibers can include side-by-side fibers and/or “island in the sea” fibers. In some embodiments, the multi-component fibers may enhance the mechanical properties of the phase and/or provide other performance advantages.

In certain embodiments, at least one phase of the pre-filter layer (e.g., a first phase, a second phase, an intermediate phase) includes one (e.g., a single) type of synthetic fiber. In certain embodiments, at least one phase of the pre-filter layer (e.g., a first phase, a second phase, an intermediate phase) comprises a blend of synthetic fibers. That is, the at least one phase of the pre-filter layer may comprise more than one type of synthetic fiber. As described further below, in some embodiments, the at least one phase of the pre-filter layer may comprise a blend of synthetic fibers comprising one or more of the following fiber types: coarse staple fibers, fine staple fibers, and fibrillated fibers. In some embodiments, the weight percentage of synthetic fibers within the pre-filter layer is greater than or equal to about 95 wt %, greater than or equal to about 99 wt %, or about 100 wt % with respect to the total weight of the pre-filter layer.

In certain embodiments, at least one phase of the pre-filter layer (e.g., a first phase, a second phase, an intermediate phase) is formed from a wet-laid process. In general, a wet-laid process involves mixing together of fibers of one or more type; for example, coarse synthetic fibers of one diameter may be mixed together with coarse synthetic fibers of another diameter, and/or with fine diameter fibers, to provide a fiber slurry. The slurry may be, for example, an aqueous-based slurry. In certain embodiments, fibers are optionally stored separately, or in combination, in various holding tanks prior to being mixed together (e.g., to achieve a greater degree of uniformity in the mixture).

For instance, a first plurality of fibers may be mixed and pulped together in one container, and a second plurality of fibers may be mixed and pulped in a separate container. The first plurality of fibers and the second plurality of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In certain embodiments, a pre-filter layer including two or more phases is formed by a wet-laid process. For example, a first dispersion (e.g., a pulp) containing fibers in a solvent (e.g., an aqueous solvent such as water) can be applied onto a wire conveyor in a papermaking machine (e.g., a fourdrinier or a rotoformer) to form a first phase supported by the wire conveyor. A second dispersion (e.g., another pulp) containing fibers in a solvent (e.g., an aqueous solvent such as water) is applied onto the first phase either at the same time or subsequent to deposition of the first layer on the wire. Vacuum is continuously applied to the first and second dispersions of fibers during the above process to remove the solvent from the fibers, thereby resulting in an article containing first and second phases. The article thus formed is then dried and, if necessary, further processed (e.g., calendered) by using known methods to form multi-phase pre-filter layers.

In some embodiments, two or more phases of a pre-filter layer are formed by separate wet-laid processes (e.g., a non-continuous process) and combined by any suitable process (e.g., adhesives, lamination, co-pleating, or collation). Other wet-laid processes may also be suitable. Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet-laid process uses similar equipment as in a conventional papermaking process, for example, a hydropulper, a former or a headbox, a dryer, and an optional converter. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under generally neutral conditions.

Before the slurry is sent to a headbox, the slurry may optionally be passed through centrifugal cleaners and/or pressure screens for removing unfiberized material. The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, a cylinder, or an inclined wire fourdrinier.

In some embodiments, a resin is added to a phase or layer (e.g., a pre-formed phase or layer formed by a wet-laid process). For instance, as the phase or layer is passed along an appropriate screen or wire, different components included in the resin (e.g., polymeric binder and/or other components), which may be in the form of separate emulsions, are added to the fiber layer using a suitable technique. In some cases, each component of the resin is mixed as an emulsion prior to being combined with the other components and/or phase/layer. The components included in the resin may be pulled through the layer using, for example, gravity and/or vacuum. In some embodiments, one or more of the components included in the resin may be diluted with softened water and pumped into the phase or layer. In some embodiments, a resin may be applied to a fiber slurry prior to introducing the slurry into a headbox. For example, the resin may be introduced (e.g., injected) into the fiber slurry and impregnated with and/or precipitated on to the fibers. In some embodiments, a resin may be added to a phase or layer by a solvent saturation process.

In some embodiments, at least one phase of the pre-filter layer (e.g., a first phase, a second phase, an intermediate phase) comprises one or more binders (e.g., binder resin, binder fiber) that serve to impart structural integrity to the pre-filter layer. In some cases, the binder may provide important mechanical properties, such as increased Gurley stiffness, Mullen burst strength, and/or tensile strength.

In some embodiments, the binder comprises one or more binder fibers as noted above. In general, binder fibers may be used to join fibers within a phase or a layer. In some embodiments, binder fibers comprise polymers with a lower melting point than one or more major components in the phase or layer, such as certain fibers. In certain embodiments, for example, a binder fiber comprises polyvinyl alcohol. Binder fibers may be mono-component or multi-component (e.g., bi-component). In certain embodiments, for example, a binder fiber may be a bi-component fiber. The bi-component fiber may comprise a thermoplastic polymer. Each component of the bi-component fiber can have a different melting temperature. For example, the fibers can include a core and a sheath where the activation temperature of the sheath is lower than the melting temperature of the core. This allows the sheath to melt prior to the core, such that the sheath binds to other fibers in the layer, while the core maintains its structural integrity. The core/sheath binder fibers can be concentric or non-concentric. Other exemplary bi-component fibers can include split fiber fibers, side-by-side fibers, and/or “island in the sea” fibers. In general, the total weight percentage of coarse and/or fine diameter fibers may include binder fibers.

In some embodiments, the total weight percentage of binder fibers (e.g., including any mono-component binder fibers and any multi-component binder fibers) within at least one phase of the pre-filter layer (e.g., a first phase, a second phase, an intermediate phase) or the entire pre-filter layer is greater than or equal to about 1 wt %, greater than or equal to about 2 wt %, greater than or equal to about 3 wt %, greater than or equal to about 4 wt %, greater than or equal to about 5 wt %, greater than or equal to about 6 wt %, greater than or equal to about 7 wt %, greater than or equal to about 8 wt %, greater than or equal to about 9 wt %, greater than or equal to about 10 wt %, greater than or equal to about 15 wt %, or greater than or equal to about 20 wt % with respect to the total weight of the at least one phase or the entire pre-filter layer. In some embodiments, the total weight percentage of binder fibers (e.g., including any mono-component binder fibers and any multi-component binder fibers) within at least one phase of the pre-filter layer (e.g., a first phase, a second phase, an intermediate phase) or the entire pre-filter layer is less than or equal to about 20 wt %, less than or equal to about 15 wt %, less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, less than or equal to about 2 wt %, or less than or equal to about 1 wt % with respect to the total weight of the at least one phase or the entire pre-filter layer. All suitable combinations of the above-referenced ranges are also possible (e.g., greater than or equal to about 1% and less than or equal to about 20%, greater than or equal to about 1% and less than or equal to about 8%).

In some embodiments, the binder comprises one or more binder resins. In general, binder resins may be used to join fibers within a phase or a layer. The binder resin may have any suitable composition. For example, the binder resin may comprise a thermoplastic polymer (e.g., acrylic, polyvinyl acetate, polyester, polyamide), a thermoset polymer (e.g., epoxy, phenolic resin), or a combination thereof. In some cases, a binder resin includes one or more of a vinyl acetate resin, an epoxy resin, a polyester resin, a copolyester resin, a polyvinyl alcohol resin, an acrylic resin such as a styrene acrylic resin, and a phenolic resin. The binder resins can also be water repellent resins, such as fluorocarbons and silicon-based resins. Other resins are also possible.

As described further below, the resin may be added to the fibers in any suitable manner including, for example, in the wet state. In some embodiments, the resin coats the fibers and is used to adhere fibers to each other to facilitate adhesion between the fibers. Any suitable method and equipment may be used to coat the fibers, for example, using curtain coating, gravure coating, melt coating, dip coating, knife roll coating, or spin coating, amongst others. In some embodiments, the binder is precipitated when added to the fiber blend. When appropriate, any suitable precipitating agent (e.g., Epichlorohydrin, fluorocarbon) may be provided to the fibers, for example, by injection into the blend. In some embodiments, upon addition to the fibers, the resin is added in a manner such that one or more layer or the entire filter media is impregnated with the resin (e.g., the resin permeates throughout). In a multi-layered web, a resin may be added to each of the layers separately prior to combining the layers, or the resin may be added to the layer after combining the layers. In some embodiments, resin is added to the fibers while in a dry state, for example, by spraying or saturation impregnation, or any of the above methods. In other embodiments, a resin is added to a wet layer.

In some embodiments, the weight percentage of a binder resin in at least one phase of the pre-filter layer (e.g., a first phase, a second phase, an intermediate phase) or the entire pre-filter layer is greater than or equal to about 10 wt %, greater than or equal to about 15 wt %, greater than or equal to about 20 wt %, greater than or equal to about 25 wt %, greater than or equal to about 30 wt %, greater than or equal to about 35 wt %, or greater than or equal to about 40 wt % with respect to the total weight of the at least one phase or the entire pre-filter layer. In some embodiments, the weight percentage of a binder resin in at least one phase of the pre-filter layer (e.g., a first phase, a second phase, an intermediate phase) or the entire pre-filter layer is less than or equal to about 40 wt %, less than or equal to about 35 wt %, less than or equal to about 30 wt %, less than or equal to about 25 wt %, less than or equal to about 20 wt %, less than or equal to about 15 wt %, or less than or equal to about 10 wt % with respect to the total weight of the at least one phase or the entire pre-filter layer. All suitable combinations of the above-referenced ranges are also possible (e.g., greater than or equal to about 10 wt % and less than or equal to about 40 wt %, greater than or equal to about 15 wt % and less than or equal to about 25 wt %).

In certain embodiments, the binder may comprise both binder fibers and binder resin.

In some embodiments, the phases of the pre-filter layer are relatively thin. In some embodiments, at least one phase of the pre-filter layer (e.g., a first phase, a second phase, an intermediate phase) has a thickness of greater than or equal to about 4 mil, greater than or equal to about 5 mil, greater than or equal to about 10 mil, greater than or equal to about 20 mil, greater than or equal to about 30 mil, greater than or equal to about 40 mil, or greater than or equal to about 50 mil. In some embodiments, at least one phase of the pre-filter layer (e.g., a first phase, a second phase, an intermediate phase) has a thickness of less than or equal to about 50 mil, less than or equal to about 40 mil, less than or equal to about 30 mil, less than or equal to about 20 mil, less than or equal to about 10 mil, less than or equal to about 5 mil, or less than or equal to about 4 mil. All suitable combinations of the above-referenced ranges are also possible (e.g., greater than or equal to about 4 mil and less than or equal to about 50 mil, greater than or equal to about 4 mil and less than or equal to about 20 mil). The thickness can be measured according to the TAPPI T411 (1997) protocol.

In some embodiments, the entire pre-filter layer is relatively thin. In some embodiments, the pre-filter layer has a thickness of greater than or equal to about 4 mil, greater than or equal to about 5 mil, greater than or equal to about 10 mil, greater than or equal to about 20 mil, greater than or equal to about 30 mil, greater than or equal to about 40 mil, greater than or equal to about 50 mil, greater than or equal to about 60 mil, greater than or equal to about 70 mil, or greater than or equal to about 80 mil. In some embodiments, the pre-filter layer has a thickness of less than or equal to about 80 mil, less than or equal to about 70 mil, less than or equal to about 60 mil, less than or equal to about 50 mil, less than or equal to about 40 mil, less than or equal to about 30 mil, less than or equal to about 20 mil, less than or equal to about 10 mil, less than or equal to about 5 mil, or less than or equal to about 4 mil. All suitable combinations of the above-referenced ranges are also possible (e.g., greater than or equal to about 4 mil and less than or equal to about 80 mil, greater than or equal to about 8 mil and less than or equal to about 30 mil).

The basis weight of the pre-filter layer as a whole and each phase within the pre-filter layer may have any suitable value. In some embodiments, the pre-filter layer has a relatively small basis weight. In some embodiments, at least one phase of the pre-filter layer (e.g., a first phase, a second phase, an intermediate phase) or the entire pre-filter layer has a basis weight of greater than or equal to about 15 g/m², greater than or equal to about 20 g/m², greater than or equal to about 30 g/m², greater than or equal to about 40 g/m², greater than or equal to about 50 g/m², greater than or equal to about 100 g/m², greater than or equal to about 150 g/m², greater than or equal to about 200 g/m², or greater than or equal to about 250 g/m². In some embodiments, at least one phase of the pre-filter layer (e.g., a first phase, a second phase, an intermediate phase) or the entire pre-filter layer has a basis weight of less than or equal to about 250 g/m², less than or equal to about 200 g/m², less than or equal to about 150 g/m², less than or equal to about 100 g/m², less than or equal to about 50 g/m², less than or equal to about 40 g/m², less than or equal to about 30 g/m², less than or equal to about 20 g/m², or less than or equal to about 15 g/m². All suitable combinations of the above-referenced ranges are also possible (e.g., greater than or equal to about 15 g/m² and less than or equal to about 250 g/m², greater than or equal to about 30 g/m² and less than or equal to about 100 g/m²). As determined herein, the basis weight is measured according to the Technical Association of the Pulp and Paper Industry (TAPPI) Standard T410 (2008). Basis weight can generally be measured on a laboratory balance that is accurate to 0.1 grams.

The specific surface area of the pre-filter layer may have any suitable value. In some embodiments, the specific surface area of the pre-filter layer is greater than or equal to about 0.2 m², greater than or equal to about 0.25 m², greater than or equal to about 0.3 m², greater than or equal to about 0.4 m², greater than or equal to about 0.5 m², greater than or equal to about 0.6 m², greater than or equal to about 0.7 m², greater than or equal to about 0.8 m², greater than or equal to about 0.9 m², greater than or equal to about 1.0 m², greater than or equal to about 1.1 m², greater than or equal to about 1.2 m², greater than or equal to about 1.3 m², greater than or equal to about 1.4 m², or greater than or equal to about 1.5 m². In some embodiments, the specific surface area of the pre-filter layer is less than or equal to about 1.5 m², less than or equal to about 1.4 m², less than or equal to about 1.3 m², less than or equal to about 1.2 m², less than or equal to about 1.1 m², less than or equal to about 1.0 m², less than or equal to about 0.9 m², less than or equal to about 0.8 m², less than or equal to about 0.7 m², less than or equal to about 0.6 m², less than or equal to about 0.5 m², less than or equal to about 0.4 m², less than or equal to about 0.3 m², or less than or equal to about 0.2 m². All suitable combinations of the above-referenced ranges are also possible (e.g., greater than or equal to about 0.2 m² and less than or equal to about 1.5 m², greater than or equal to about 0.25 m² and less than or equal to about 0.7 m²). The BET surface area is measured according to section 10 of Battery Council International Standard BCIS-03A, “Recommended Battery Materials Specifications Valve Regulated Recombinant Batteries,” section 10 being “Standard Test Method for Surface Area of Recombinant Battery Separator Mat.” Following this technique, the BET surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and the sample is allowed to degas at 75 degrees Celsius for a minimum of 3 hours.

In some embodiments, the pre-filter layer has a relatively high Gurley stiffness. In certain embodiments, for example, the pre-filter layer has sufficient Gurley stiffness in the machine direction and/or cross direction that the filter media can be pleated to include sharp, well-defined peaks, which can be maintained in a stable configuration during use. In some embodiments, the pre-filter layer has a Gurley stiffness in the machine direction of greater than or equal to about 150 mg, greater than or equal to about 200 mg, greater than or equal to about 300 mg, greater than or equal to about 400 mg, greater than or equal to about 500 mg, greater than or equal to about 600 mg, greater than or equal to about 700 mg, greater than or equal to about 800 mg, greater than or equal to about 900 mg, greater than or equal to about 1000 mg, greater than or equal to about 1500 mg, greater than or equal to about 2000 mg, greater than or equal to about 2500 mg, greater than or equal to about 3000 mg, or greater than or equal to about 3500 mg. In some embodiments, the pre-filter layer has a Gurley stiffness in the machine direction of less than or equal to about 3500 mg, less than or equal to about 3000 mg, less than or equal to about 2500 mg, less than or equal to about 2000 mg, less than or equal to about 1500 mg, less than or equal to about 1000 mg, less than or equal to about 900 mg, less than or equal to about 800 mg, less than or equal to about 700 mg, less than or equal to about 600 mg, less than or equal to about 500 mg, less than or equal to about 400 mg, less than or equal to about 300 mg, less than or equal to about 200 mg, or less than or equal to about 150 mg. All suitable combinations of the above-referenced ranges are also possible (e.g., greater than or equal to about 150 mg and less than or equal to about 3500 mg, greater than or equal to about 200 mg and less than or equal to about 1500 mg). Stiffness in the machine direction may be determined using the Gurley stiffness (bending resistance) recorded in units of mm (equivalent to gu) in accordance with TAPPI T543 om-94 (2000).

In some embodiments, the pre-filter layer has a relatively high Gurley stiffness in the cross direction. In some embodiments, the pre-filter layer has a Gurley stiffness in the cross direction of greater than or equal to about 150 mg, greater than or equal to about 200 mg, greater than or equal to about 300 mg, greater than or equal to about 400 mg, greater than or equal to about 500 mg, greater than or equal to about 600 mg, greater than or equal to about 700 mg, greater than or equal to about 800 mg, greater than or equal to about 900 mg, greater than or equal to about 1000 mg, greater than or equal to about 1500 mg, greater than or equal to about 2000 mg, greater than or equal to about 2500 mg, greater than or equal to about 3000 mg, or greater than or equal to about 3500 mg. In some embodiments, the pre-filter layer has a Gurley stiffness in the cross direction of less than or equal to about 3500 mg, less than or equal to about 3000 mg, less than or equal to about 2500 mg, less than or equal to about 2000 mg, less than or equal to about 1500 mg, less than or equal to about 1000 mg, less than or equal to about 900 mg, less than or equal to about 800 mg, less than or equal to about 700 mg, less than or equal to about 600 mg, less than or equal to about 500 mg, less than or equal to about 400 mg, less than or equal to about 300 mg, less than or equal to about 200 mg, or less than or equal to about 150 mg. All suitable combinations of the above-referenced ranges are also possible (e.g., greater than or equal to about 150 mg and less than or equal to about 3500 mg, greater than or equal to about 200 mg and less than or equal to about 1500 mg). Stiffness in the cross direction may be determined using the Gurley stiffness (bending resistance) recorded in units of mm (equivalent to gu) in accordance with TAPPI T543 om-94 (2000).

In some embodiments, the pre-filter layer has a relatively high tensile strength. In some embodiments, the pre-filter layer has a dry tensile strength in the machine direction greater than or equal to about 2 lb/in, greater than or equal to about 5 lb/in, greater than or equal to about 8 lb/in, greater than or equal to about 10 lb/in, greater than or equal to about 15 lb/in, greater than or equal to about 20 lb/in, greater than or equal to about 30 lb/in, greater than or equal to about 40 lb/in, greater than or equal to about 50 lb/in, or greater than or equal to about 60 lb/in. In some embodiments, the pre-filter layer has a dry tensile strength in the machine direction of less than or equal to about 60 lb/in, less than or equal to about 50 lb/in, less than or equal to about 40 lb/in, less than or equal to about 30 lb/in, less than or equal to about 20 lb/in, less than or equal to about 15 lb/in, less than or equal to about 10 lb/in, less than or equal to about 8 lb/in, less than or equal to about 5 lb/in, or less than or equal to about 2 lb/in. All suitable combinations of the above-referenced ranges are also possible (e.g., greater than or equal to about 2 lb/in and less than or equal to about 60 lb/in, greater than or equal to about 8 lb/in and less than or equal to about 30 lb/in). Dry tensile strength in the machine direction may be determined according to the ISO 1924-2 protocol.

In some embodiments, the pre-filter layer has a relatively high air permeability. In some embodiments, the pre-filter layer has an air permeability of greater than or equal to about 10 CFM, greater than or equal to about 15 CFM, greater than or equal to about 20 CFM, greater than or equal to about 50 CFM, greater than or equal to about 100 CFM, greater than or equal to about 200 CFM, greater than or equal to about 300 CFM, greater than or equal to about 400 CFM, or greater than or equal to about 500 CFM. In some embodiments, the pre-filter layer has an air permeability of less than or equal to about 500 CFM, less than or equal to about 400 CFM, less than or equal to about 300 CFM, less than or equal to about 200 CFM, less than or equal to about 100 CFM, less than or equal to about 50 CFM, less than or equal to about 20 CFM, less than or equal to about 15 CFM, or less than or equal to about 10 CFM. All suitable combinations of the above-referenced ranges are also possible (e.g., greater than or equal to about 10 CFM and less than or equal to about 500 CFM, greater than or equal to about 15 CFM and less than or equal to about 400 CFM). Air permeability may be determined according to TAPPI T-251 (1996), for example, using a Textest FX 3300 air permeability tester III (Textest AG, Zurich), a sample area of 38 cm², and a pressure drop of 0.5 inches of water to obtain the Frazier permeability value in CFM.

In some embodiments, the pre-filter layer has a relatively high initial DOP efficiency. In some embodiments, the initial DOP efficiency of the pre-filter layer is greater than or equal to about 1%, greater than or equal to about 2%, greater than or equal to about 5%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, or greater than or equal to about 50%. In some embodiments, the initial DOP efficiency of the pre-filter layer is less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, less than or equal to about 5%, less than or equal to about 2%, or less than or equal to about 1%. All suitable combinations of the above-referenced ranges are also possible (e.g., greater than or equal to about 1% and less than or equal to about 50%, greater than or equal to about 5% and less than or equal to about 20%). The initial DOP efficiency of a layer (e.g., a pre-filter layer) may be measured by blowing dioctyl phthalate (DOP) particles through the layer (a new, unused layer) and measuring the percentage of particles that penetrate through the layer. The initial DOP efficiency can be calculated by subtracting the initial penetration percentage from 100. The initial penetration percentage may be measured using a 100P Oil Aerosol Automated Filter Tester from Air Technologies International (ATI) after 20 seconds of loading of DOP particles having an average diameter of 0.3 μm at a face velocity of 5.3 cm/s.

In some embodiments, the pre-filter layer has a relatively high mean flow pore size. In some embodiments, the mean flow pore size of the pre-filter layer is greater than or equal to about 2 μm, greater than or equal to about 4 μm, greater than or equal to about 6 μm, greater than or equal to about 8 μm, greater than or equal to about 10 μm, greater than or equal to about 20 μm, greater than or equal to about 30 μm, greater than or equal to about 40 μm, greater than or equal to about 50 μm, greater than or equal to about 60 μm, greater than or equal to about 70 μm, or greater than or equal to about 80 μm. In some embodiments, the mean flow pore size of the pre-filter layer is less than or equal to about 80 μm, less than or equal to about 70 μm, less than or equal to about 60 μm, less than or equal to about 50 μm, less than or equal to about 40 μm, less than or equal to about 30 μm, less than or equal to about 20 μm, less than or equal to about 10 μm, less than or equal to about 8 μm, less than or equal to about 6 μm, less than or equal to about 4 μm, or less than or equal to about 2 μm. All suitable combinations of the above-referenced ranges are also possible (e.g., greater than or equal to about 2 μm and less than or equal to about 80 μm, greater than or equal to about 4 μm and less than or equal to about 50 μm). The mean flow pore size is measured by using a Coulter Porometer as described in ASTM F316-03 (2011).

In some embodiments, the pre-filter layer has a relatively high gamma value. High gamma values generally are indicative of better filter performance (i.e., high particulate efficiency as a function of pressure drop). In particular, the gamma value can be calculated according to the following formula:

gamma=(−log₁₀(initial penetration %/100)/initial pressure drop, Pa)×100×9.8, which is equivalent to:

gamma=(−log₁₀(initial penetration %/100)/initial pressure drop, mm H₂O)×100,

wherein initial penetration %=100−initial efficiency
where initial pressure drop and initial penetration percentage are measured using an 100P Oil Aerosol Automated Filter Tester from Air Technologies International (ATI) after 20 seconds of loading of DOP particles having an average diameter of 0.3 μm at a face velocity of 5.3 cm/s. The initial pressure drop and initial penetration values are obtained using a new, unused layer.

With decreased initial penetration percentage (i.e., increased particulate efficiency) where particles are less able to penetrate through the pre-filter layer, the gamma value increases. With decreased initial pressure drop (i.e., low resistance to fluid flow), the gamma value increases. These generalized relationships between initial penetration, initial pressure drop, and/or gamma value assume that the other properties remain constant.

In some embodiments, the pre-filter layer has a gamma value of greater than or equal to about 2, greater than or equal to about 3, greater than or equal to about 4, greater than or equal to about 5, greater than or equal to about 6, greater than or equal to about 7, greater than or equal to about 8, greater than or equal to about 9, greater than or equal to about 10, greater than or equal to about 11, greater than or equal to about 12, greater than or equal to about 13, greater than or equal to about 14, or greater than or equal to about 15. In some embodiments, the pre-filter layer has a gamma value of less than or equal to about 15, less than or equal to about 14, less than or equal to about 13, less than or equal to about 12, less than or equal to about 11, less than or equal to about 10, less than or equal to about 9, less than or equal to about 8, less than or equal to about 7, less than or equal to about 6, less than or equal to about 5, less than or equal to about 4, less than or equal to about 3, or less than or equal to about 2. All suitable combinations of the above-referenced ranges are also possible (e.g., greater than or equal to about 2 and less than or equal to about 15, greater than or equal to about 3 and less than or equal to about 12).

In some embodiments, the pre-filter layer has a relatively high dry Mullen burst strength. In some embodiments, the pre-filter layer has a dry Mullen burst strength of greater than or equal to 20 psi, greater than or equal to 30 psi, greater than or equal to 40 psi, greater than or equal to 50 psi, greater than or equal to 100 psi, greater than or equal to 150 psi, greater than or equal to 200 psi, or greater than or equal to 250 psi. In some embodiments, the pre-filter layer has a dry Mullen burst strength of less than or equal to 250 psi, less than or equal to 200 psi, less than or equal to 150 psi, less than or equal to 100 psi, less than or equal to 50 psi, less than or equal to 40 psi, less than or equal to 30 psi, or less than or equal to 20 psi. All suitable combinations of the above-referenced ranges are also possible (e.g., greater than or equal to about 20 psi and less than or equal to about 250 psi, greater than or equal to about 30 psi and less than or equal to about 150 psi). The dry Mullen burst strength may be determined according to the standard T403 om-91 (1997).

In some embodiments, the filter media comprises a main filter layer comprising a plurality of fibers. In certain embodiments, the plurality of fibers comprises synthetic fibers, amongst other fiber types. Non-limiting examples of suitable synthetic fibers include polyesters (e.g., polyethylene terephthalate, polybutylene terephthalate), polycarbonate, polyamides (e.g., various nylon polymers), polyaramid, polyimide, polyethylene, polypropylene, polyether ether ketone, polyolefin, acrylics, polyvinyl alcohol, regenerated cellulose (e.g., synthetic cellulose such lyocell, rayon), polyacrylonitriles, polyvinylidene fluoride (PVDF), copolymers of polyethylene and PVDF, polyethersulfone, and combinations thereof. In some embodiments, the main filter media comprises synthetic fibers formed from an electrospinning process, a solvent spinning process, a meltblown process, a melt spinning process, and/or a centrifugal spinning process. In some embodiments, the weight percentage of synthetic fibers in the main filter layer is greater than or equal to about 95 wt %, greater than or equal to about 99 wt %, or about 100 wt % with respect to the total weight of the main filter layer. In some embodiments, 100% of the fibers within the main filter layer are synthetic fibers.

In some embodiments, the fibers in the main filter layer have a relatively small average fiber diameter. In some embodiments, the average fiber diameter is greater than or equal to 50 nm, greater than or equal to 60 nm, greater than or equal to 70 nm, greater than or equal to 80 nm, greater than or equal to 90 nm, greater than or equal to 100 nm, greater than or equal to 200 nm, greater than or equal to 300 nm, greater than or equal to 400 nm, greater than or equal to 500 nm, greater than or equal to 600 nm, greater than or equal to 700 nm, greater than or equal to 800 nm, greater than or equal to 900 nm, greater than or equal to 1 μm, greater than or equal to 2 μm, greater than or equal to 3 μm, or greater than or equal to 4 μm. In some embodiments, the average fiber diameter is less than or equal to 4 μm, less than or equal to 3 μm, less than or equal to 2 μm, less than or equal to 1 μm, less than or equal to 900 nm, less than or equal to 800 nm, less than or equal to 700 nm, less than or equal to 600 nm, less than or equal to 500 nm, less than or equal to 400 nm, less than or equal to 300 nm, less than or equal to 200 nm, less than or equal to 100 nm, less than or equal to 90 nm, less than or equal to 80 nm, less than or equal to 70 nm, less than or equal to 60 nm, or less than or equal to 50 nm. All suitable combinations of the above-referenced ranges are also possible (e.g., greater than or equal to about 50 nm and less than or equal to about 4 μm, greater than or equal to about 70 nm and less than or equal to about 400 nm).

In some embodiments, the fibers in the main filter layer have a length that may depend on the method of formation of the fibers. In some cases, the fibers (e.g., synthetic fibers) may be continuous (e.g., electrospun fibers, meltblown fibers, spunbond fibers, centrifugal spun fibers, etc.). For instance, the fibers in the main filter layer may have an average length of greater than or equal to about 5 cm, greater than or equal to about 10 cm, greater than or equal to about 15 cm, greater than or equal to about 20 cm, greater than or equal to about 50 cm, greater than or equal to about 100 cm, greater than or equal to about 200 cm, greater than or equal to about 500 cm, greater than or equal to about 700 cm, greater than or equal to about 1000, greater than or equal to about 1500 cm, greater than or equal to about 2000 cm, greater than or equal to about 2500 cm, greater than or equal to about 5000 cm, greater than or equal to about 10000 cm. In some embodiments, the fibers in the main filter layer have an average fiber length of less than or equal to about 10000 cm, less than or equal to about 5000 cm, less than or equal to about 2500 cm, less than or equal to about 2000 cm, less than or equal to about 1000 cm, less than or equal to about 500 cm, or less than or equal to about 200 cm. All suitable combinations of the above-referenced ranges are also possible (e.g., greater than or equal to about 5 cm and less than or equal to about 10000 cm).

In other embodiments, the fibers (e.g., synthetic fibers) are not continuous (e.g., the synthetic fibers are staple fibers). In general, synthetic non-continuous fibers may be characterized as being shorter than continuous synthetic fibers. For instance, in some embodiments, the fibers in the main filter layer have an average length of greater than or equal to about 0.1 mm, greater than or equal to about 0.3 mm, greater than or equal to about 0.5 mm, greater than or equal to about 0.8 mm, greater than or equal to about 1 mm, greater than or equal to about 3 mm, greater than or equal about 6 mm, greater than or equal about 9 mm, greater than or equal about 12 mm, greater than or equal about 15 mm, greater than or equal about 18 mm, greater than or equal about 20 mm, greater than or equal about 22 mm, greater than or equal about 25 mm, greater than or equal about 28 mm, greater than or equal about 30 mm, greater than or equal about 32 mm, greater than or equal about 35 mm, greater than or equal about 38 mm, greater than or equal about 40 mm, greater than or equal about 42 mm, or greater than or equal about 45 mm. In some instances, the average length of the fibers in the main filter layer is less than or equal to about 50 mm, less than or equal to about 48 mm, less than or equal to about 45 mm, less than or equal to about 42 mm, less than or equal to about 40 mm, less than or equal to about 38 mm, less than or equal to about 35 mm, less than or equal to about 32 mm, less than or equal to about 30 mm, less than or equal to about 27 mm, less than or equal to about 25 mm, less than or equal to about 22 mm, less than or equal to about 20 mm, less than or equal to about 18 mm, less than or equal to about 15 mm, less than or equal to about 12 mm, less than or equal to about 9 mm, less than or equal to about 6 mm, less than or equal to about 3 mm, or less than or equal to about 1 mm. All suitable combinations of the above-referenced ranges are also possible (e.g., greater than or equal about 0.1 mm and less than or equal to about 30 mm, greater than or equal about 0.3 mm and less than or equal to about 12 mm).

In some embodiments, the weight percentage of a particular type of fiber (e.g., a particular type of synthetic fiber) within the main filter layer is greater than or equal to about 10 wt %, greater than or equal to about 20 wt %, greater than or equal to about 30 wt %, greater than or equal to about 40 wt %, greater than or equal to about 50 wt %, greater than or equal to about 60 wt %, greater than or equal to about 70 wt %, greater than or equal to about 80 wt %, greater than or equal to about 90 wt %, greater than or equal to about 95 wt %, or about 100 wt % with respect to the total weight of the main filter layer. In some embodiments, the weight percentage of a particular type of fiber (e.g., a particular type of synthetic fiber) within the main filter layer is less than or equal to about 100 wt %, less than or equal to about 95 wt %, less than or equal to about 90 wt %, less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10 wt % with respect to the total weight of the main filter layer. All suitable combinations of the above-referenced ranges are also possible (e.g., greater than or equal to about 10 wt % and less than or equal to about 100 wt %, greater than or equal to about 50 wt % and less than or equal to about 100 wt %). In some embodiments, the weight percentage of synthetic fibers is about 100 wt % with respect to the total weight of the main filter layer.

In some embodiments, the main filter layer is relatively thin. The main filter layer may have a thickness of greater than or equal to about 0.0001 mil, greater than or equal to about 0.0005 mil, greater than or equal to about 0.001 mil, greater than or equal to about 0.005 mil, greater than or equal to about 0.01 mil, greater than or equal to about 0.05 mil, greater than or equal to about 0.1 mil, greater than or equal to about 0.5 mil, greater than or equal to about 1 mil, greater than or equal to about 2 mil, greater than or equal to about 3 mil, or greater than or equal to about 4 mil. In some embodiments, the main filter layer has a thickness of less than or equal to about 4 mil, less than or equal to about 3 mil, less than or equal to about 2 mil, less than or equal to about 1 mil, less than or equal to about 0.5 mil, less than or equal to about 0.1 mil, less than or equal to about 0.05 mil, less than or equal to about 0.01 mil, less than or equal to about 0.005 mil, less than or equal to about 0.001 mil, less than or equal to about 0.0005 mil, or less than or equal to about 0.0001 mil. All suitable combinations of the above-referenced ranges are also possible (e.g., greater than or equal to about 0.0001 mil and less than or equal to about 4 mil, greater than or equal to about 0.0001 mil and less than or equal to about 2 mil). The thickness of the main filter layer can be measured from a cross-sectional SEM image.

In some embodiments, the thickness of the main filter layer is substantially less than the thickness of the pre-filter layer. In some such embodiments, the ratio of the thickness of the pre-filter layer to the thickness of the main filter layer is relatively large. In some embodiments, the thickness ratio is greater than or equal to about 6, greater than or equal to about 8, greater than or equal to about 10, greater than or equal to about 15, greater than or equal to about 20, greater than or equal to about 50, greater than or equal to about 80, greater than or equal to about 100, greater than or equal to about 200, greater than or equal to about 500, greater than or equal to about 800, greater than or equal to about 1000, greater than or equal to about 2000, greater than or equal to about 5000, greater than or equal to about 8000, or greater than or equal to about 10,000. In some embodiments, the thickness ratio is less than or equal to about 10,000, less than or equal to about 8000, less than or equal to about 5000, less than or equal to about 2000, less than or equal to about 1000, less than or equal to about 800, less than or equal to about 500, less than or equal to about 200, less than or equal to about 100, less than or equal to about 80, less than or equal to about 50, less than or equal to about 20, less than or equal to about 15, less than or equal to about 10, less than or equal to about 8, or less than or equal to about 6. All suitable combinations of the above-referenced ranges are also possible (e.g., greater than or equal to about 6 and less than or equal to about 10,000, greater than or equal to about 10 and less than or equal to about 10,000).

The basis weight of the main filter layer may have any suitable value. In some embodiments, the main filter layer has a relatively small basis weight. In some embodiments, the main filter layer has a basis weight of greater than or equal to about 0.0001 g/m², greater than or equal to about 0.0005 g/m², greater than or equal to about 0.001 g/m², greater than or equal to about 0.005 g/m², greater than or equal to about 0.01 g/m², greater than or equal to about 0.05 g/m², greater than or equal to about 0.1 g/m², or greater than or equal to about 0.5 g/m². In some embodiments, the main filter layer has a basis weight of less than or equal to about 0.5 g/m², less than or equal to about 0.1 g/m², less than or equal to about 0.05 g/m², less than or equal to about 0.01 g/m², less than or equal to about 0.005 g/m², less than or equal to about 0.001 g/m², less than or equal to about 0.0005 g/m², or less than or equal to about 0.0001 g/m². All suitable combinations of the above-referenced ranges are also possible (e.g., greater than or equal to about 0.0001 g/m² and less than or equal to about 0.5 g/m², greater than or equal to about 0.0001 g/m² and less than or equal to about 0.3 g/m²).

The main filter layer may have any suitable air permeability. In some embodiments, the main filter layer has an air permeability of greater than or equal to about 10 CFM, greater than or equal to about 15 CFM, greater than or equal to about 20 CFM, greater than or equal to about 50 CFM, greater than or equal to about 100 CFM, greater than or equal to about 200 CFM, greater than or equal to about 300 CFM, greater than or equal to about 400 CFM, greater than or equal to about 500 CFM, greater than or equal to about 600 CFM, greater than or equal to about 700 CFM, greater than or equal to about 800 CFM, greater than or equal to about 900 CFM, or greater than or equal to about 1000 CFM. In some embodiments, the main filter layer has an air permeability of less than or equal to about 1000 CFM, less than or equal to about 900 CFM, 800 CFM, less than or equal to about 700 CFM, less than or equal to about 600 CFM, less than or equal to about 500 CFM, less than or equal to about 400 CFM, less than or equal to about 300 CFM, less than or equal to about 200 CFM, less than or equal to about 100 CFM, less than or equal to about 50 CFM, less than or equal to about 20 CFM, less than or equal to about 15 CFM, or less than or equal to about 10 CFM. All suitable combinations of the above-referenced ranges are also possible (e.g., greater than or equal to about 10 CFM and less than or equal to about 1000 CFM, greater than or equal to about 15 CFM and less than or equal to about 100 CFM).

The main filter layer may have any suitable initial DOP efficiency. In some embodiments, the initial DOP efficiency of the main filter layer is greater than or equal to about 20%, greater than or equal to about 30%, greater than or equal to about 40%, greater than or equal to about 50%, or greater than or equal to about 60%, greater than or equal to about 70%, greater than or equal to about 80%, greater than or equal to about 90%, greater than or equal to about 95%, or greater than or equal to about 99%. In some embodiments, the initial DOP efficiency of the main filter layer is less than or equal to about 99%, less than or equal to about 95%, less than or equal to about 90%, less than or equal to about 80%, less than or equal to about 70%, less than or equal to about 60%, less than or equal to about 50%, less than or equal to about 40%, less than or equal to about 30%, or less than or equal to about 20%. All suitable combinations of the above-referenced ranges are also possible (e.g., greater than or equal to about 20% and less than or equal to about 99%, greater than or equal to about 50% and less than or equal to about 90%).

The main filter layer may have a relatively high gamma value. In some embodiments, the main filter layer has a gamma value of greater than or equal to 20, greater than or equal to 25, greater than or equal to 30, greater than or equal to 40, greater than or equal to 50, greater than or equal to 60, greater than or equal to 70, or greater than or equal to 80. In some embodiments, the gamma value of the main filter layer is less than or equal to 80, less than or equal to 70, less than or equal to 60, less than or equal to 50, less than or equal to 40, less than or equal to 30, or less than or equal to 20. All suitable combinations of the above-referenced ranges are also possible (e.g., greater than or equal to about 20 and less than or equal to about 80, greater than or equal to about 25 and less than or equal to about 60).

In some embodiments, the filter media comprises a protective layer. In some embodiments, the protective layer is positioned as an outer layer of the filter media (e.g., on a downstream side of the main filter layer). The protective layer may be formed according to any suitable process. Non-limiting examples of suitable processes include a spunbond process, a meltblown process, and carded webs.

In some embodiments, the protective layer comprises synthetic fibers. Non-limiting examples of suitable fibers include thermoplastic polymers such as polyesters (e.g., poly(butylene terephthalate), poly(butylene naphthalate), poly(ethylene terephthalate) (PET), poly(lactic acid)), polyolefins (e.g., polyethylene, polypropylene), polyamides (e.g., nylon, aramids), polyalkylenes, polyacrylonitriles, polyphenylene sulfides, polycarbonates, thermoplastic polyurethanes, polyimide, and polystyrene. In certain instances, the fibers of the protective layer comprise a polyolefin and/or a polyester. In some cases, the weight percentage of synthetic fibers in the protective layer is greater than or equal to about 95 wt %, greater than or equal to about 99 wt %, or about 100% with respect to the total weight of the protective layer. In some embodiments, 100% of the fibers within the protective layer are synthetic fibers. In some embodiments, the fibers of the protective layer comprise glass fibers.

In some embodiments, the fibers of the protective layer have a relatively large average fiber diameter. In some embodiments, the average fiber diameter is greater than or equal to 1 μm, greater than or equal to 2 μm, greater than or equal to 3 μm, greater than or equal to 4 μm, greater than or equal to 5 μm, greater than or equal to 10 μm, greater than or equal to 15 μm, greater than or equal to 20 μm, greater than or equal to 25 μm, greater than or equal to 30 μm, greater than or equal to 35 μm, or greater than or equal to 40 μm. In some embodiments, the average fiber diameter is less than or equal to 40 μm, less than or equal to 35 μm, less than or equal to 30 μm, less than or equal to 25 μm, less than or equal to 20 μm, less than or equal to 15 μm, less than or equal to 10 μm, less than or equal to 5 μm, less than or equal to 4 μm, less than or equal to 3 μm, less than or equal to 2 μm, or less than or equal to 1 μm. All suitable combinations of the above-referenced ranges are also possible (e.g., greater than or equal to about 1 μm and less than or equal to about 40 μm, greater than or equal to about 2 μm and less than or equal to about 20 μm).

In some embodiments, the fibers in the protective layer have a length that may depend on the method of formation of the fibers. In some cases, the fibers (e.g., synthetic fibers) may be continuous (e.g., electrospun fibers, meltblown fibers, spunbond fibers, centrifugal spun fibers, etc.). For instance, the fibers in the protective layer may have an average length of greater than or equal to about 5 cm, greater than or equal to about 10 cm, greater than or equal to about 15 cm, greater than or equal to about 20 cm, greater than or equal to about 50 cm, greater than or equal to about 100 cm, greater than or equal to about 200 cm, greater than or equal to about 500 cm, greater than or equal to about 700 cm, greater than or equal to about 1000, greater than or equal to about 1500 cm, greater than or equal to about 2000 cm, greater than or equal to about 2500 cm, greater than or equal to about 5000 cm, greater than or equal to about 10000 cm. In some embodiments, the fibers in the protective layer have an average fiber length of less than or equal to about 10000 cm, less than or equal to about 5000 cm, less than or equal to about 2500 cm, less than or equal to about 2000 cm, less than or equal to about 1000 cm, less than or equal to about 500 cm, or less than or equal to about 200 cm. All suitable combinations of the above-referenced ranges are also possible (e.g., greater than or equal to about 5 cm and less than or equal to about 10000 cm).

In other embodiments, the fibers (e.g., synthetic fibers) are not continuous (e.g., the synthetic fibers are staple fibers). In general, synthetic non-continuous fibers may be characterized as being shorter than continuous synthetic fibers. For instance, the fibers in the protective layer may have an average length of greater than or equal to about 0.1 mm, greater than or equal to about 0.3 mm, greater than or equal to about 0.5 mm, greater than or equal to about 0.8 mm, greater than or equal to about 1 mm, greater than or equal to about 3 mm, greater than or equal about 6 mm, greater than or equal about 9 mm, greater than or equal about 12 mm, greater than or equal about 15 mm, greater than or equal about 18 mm, greater than or equal about 20 mm, greater than or equal about 22 mm, greater than or equal about 25 mm, greater than or equal about 28 mm, greater than or equal about 30 mm, greater than or equal about 32 mm, greater than or equal about 35 mm, greater than or equal about 38 mm, greater than or equal about 40 mm, greater than or equal about 42 mm, or greater than or equal about 45 mm. In some embodiments, the average length of the fibers in the protective layer is less than or equal to about 50 mm, less than or equal to about 48 mm, less than or equal to about 45 mm, less than or equal to about 42 mm, less than or equal to about 40 mm, less than or equal to about 38 mm, less than or equal to about 35 mm, less than or equal to about 32 mm, less than or equal to about 30 mm, less than or equal to about 27 mm, less than or equal to about 25 mm, less than or equal to about 22 mm, less than or equal to about 20 mm, less than or equal to about 18 mm, less than or equal to about 15 mm, less than or equal to about 12 mm, less than or equal to about 9 mm, less than or equal to about 6 mm, less than or equal to about 3 mm, or less than or equal to about 1 mm. All suitable combinations of the above-referenced ranges are also possible (e.g., greater than or equal about 0.1 mm and less than or equal to about 30 mm, greater than or equal about 0.3 mm and less than or equal to about 12 mm).

In some embodiments, the weight percentage of a particular fiber within the protective layer is greater than or equal to 0 wt %, greater than or equal to about 10 wt %, greater than or equal to about 20 wt %, greater than or equal to about 30 wt %, greater than or equal to about 40 wt %, greater than or equal to about 50 wt %, greater than or equal to about 60 wt %, greater than or equal to about 70 wt %, greater than or equal to about 80 wt %, greater than or equal to about 90 wt %, greater than or equal to about 95 wt %, or greater than or equal to 100 wt % with respect to the total weight of the protective layer. In some embodiments, the weight percentage of a particular fiber within the protective layer is less than or equal to about 100 wt %, less than or equal to about 95 wt %, less than or equal to about 90 wt %, less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, less than or equal to about 10 wt %, or about 0 wt % with respect to the total weight of the protective layer. All suitable combinations of the above-referenced ranges are also possible (e.g., greater than or equal to about 0 wt % and less than or equal to about 100 wt %, greater than or equal to about 50 wt % and less than or equal to about 90 wt %).

In some embodiments, the protective layer may not use any resins. In other embodiments, the protective layer may comprise one or more binder resins. In general, binder resin may be used to join fibers within the layer. The binder resin may have any suitable composition. For example, the binder resin may comprise a thermoplastic (e.g., acrylic, polyvinylacetate, polyester, polyamide), a thermoset (e.g., epoxy, phenolic resin), or a combination thereof. In some cases, a binder resin includes one or more of a vinyl acetate resin, an epoxy resin, a polyester resin, a copolyester resin, a polyvinyl alcohol resin, an acrylic resin such as a styrene acrylic resin, and a phenolic resin. Other resins are also possible.

In some embodiments, the weight percentage of a binder resin within the protective layer is greater than or equal to 0 wt %, greater than or equal to about 5 wt %, greater than or equal to about 10 wt %, greater than or equal to about 15 wt %, greater than or equal to about 20 wt %, greater than or equal to about 25 wt %, or greater than or equal to about 30 wt % with respect to the total weight of the protective layer. In some embodiments, the weight percentage of a binder resin within the protective layer is less than or equal to about 30 w%, less than or equal to about 25 wt %, less than or equal to about 20 wt %, less than or equal to about 15 wt %, less than or equal to about 10 wt %, less than or equal to about 5 wt %, or about 0 wt % with respect to the total weight of the protective layer. All suitable combinations of the above-referenced ranges are also possible (e.g., greater than or equal to about 0 wt % and less than or equal to about 30 wt %, greater than or equal to about 0 wt % and less than or equal to about 15 wt %).

The protective layer may have any suitable thickness. In some embodiments, the protective layer has a thickness of greater than or equal to about 1 mil, greater than or equal to about 2 mil, greater than or equal to about 3 mil, greater than or equal to about 4 mil, greater than or equal to about 5 mil, greater than or equal to about 6 mil, greater than or equal to about 7 mil, greater than or equal to about 8 mil, greater than or equal to about 9 mil, greater than or equal to about 10 mil, greater than or equal to about 15 mil, greater than or equal to about 20 mil, greater than or equal to about 25 mil, greater than or equal to about 30 mil, greater than or equal to about 35 mil, greater than or equal to about 40 mil, greater than or equal to about 45 mil, or greater than or equal to about 50 mil. In some embodiments, the protective layer has a thickness of less than or equal to about 50 mil, less than or equal to about 45 mil, less than or equal to about 40 mil, less than or equal to about 35 mil, less than or equal to about 30 mil, less than or equal to about 25 mil, less than or equal to about 20 mil, less than or equal to about 15 mil, less than or equal to about 10 mil, less than or equal to about 9 mil, less than or equal to about 8 mil, less than or equal to about 7 mil, less than or equal to about 6 mil, less than or equal to about 5 mil, less than or equal to about 4 mil, less than or equal to about 3 mil, less than or equal to about 2 mil, or less than or equal to about 1 mil. All suitable combinations of the above-referenced ranges are possible (e.g., greater than or equal to about 1 mil and less than or equal to about 50 mil, greater than or equal to about 2 mil and less than or equal to about 15 mil).

In some embodiments, the ratio of the thickness of the protective layer to the thickness of the main filter layer is relatively large. In some embodiments, the thickness ratio is greater than or equal to about 6, greater than or equal to about 8, greater than or equal to about 10, greater than or equal to about 15, greater than or equal to about 20, greater than or equal to about 50, greater than or equal to about 80, greater than or equal to about 100, greater than or equal to about 200, greater than or equal to about 500, greater than or equal to about 800, greater than or equal to about 1000, greater than or equal to about 2000, greater than or equal to about 5000, greater than or equal to about 8000, greater than or equal to about 10,000, greater than or equal to about 15,000, greater than or equal to about 20,000, greater than or equal to about 25,000, or greater than or equal to about 30,000. In some embodiments, the thickness ratio is less than or equal to about 30,000, less than or equal to about 25,000, less than or equal to about 20,000, less than or equal to about 15,000, less than or equal to about 10,000, less than or equal to about 8000, less than or equal to about 5000, less than or equal to about 2000, less than or equal to about 1000, less than or equal to about 800, less than or equal to about 500, less than or equal to about 200, less than or equal to about 100, less than or equal to about 80, less than or equal to about 50, less than or equal to about 20, less than or equal to about 15, less than or equal to about 10, less than or equal to about 8, or less than or equal to about 6. All suitable combinations of the above-referenced ranges are also possible (e.g., greater than or equal to about 6 and less than or equal to about 15,000, greater than or equal to about 10 and less than or equal to about 15,000).

The basis weight of the protective layer may have any suitable value. In some embodiments, the protective layer has a basis weight of greater than or equal to about 5 g/m², greater than or equal to about 10 g/m², greater than or equal to about 15 g/m², greater than or equal to about 20 g/m², greater than or equal to about 25 g/m², greater than or equal to about 30 g/m², greater than or equal to about 35 g/m², or greater than or equal to about 40 g/m². In some embodiments, the protective layer has a basis weight of less than or equal to about 40 g/m², less than or equal to about 35 g/m², less than or equal to about 30 g/m², less than or equal to about 25 g/m², less than or equal to about 20 g/m², less than or equal to about 15 g/m², less than or equal to about 10 g/m², or less than or equal to about 5 g/m². All suitable combinations of the above-referenced ranges are also possible (e.g., greater than or equal to about 5 g/m² and less than or equal to about 40 g/m², greater than or equal to about 10 g/m² and less than or equal to about 30 g/m²).

The Gurley stiffness of the protective layer in the machine direction may have any suitable value. In some embodiments, the protective layer has a Gurley stiffness in the machine direction of greater than or equal to about 10 mg, greater than or equal to about 20 mg, greater than or equal to about 50 mg, greater than or equal to about 100 mg, greater than or equal to about 200 mg, greater than or equal to about 500 mg, greater than or equal to about 1000 mg, greater than or equal to about 1500 mg, greater than or equal to about 2000 mg, greater than or equal to about 2500 mg, or greater than or equal to about 3000 mg. In some embodiments, the protective layer has a Gurley stiffness in the machine direction of less than or equal to about 3000 mg, less than or equal to about 2500 mg, less than or equal to about 2000 mg, less than or equal to about 1500 mg, less than or equal to about 1000 mg, less than or equal to about 500 mg, less than or equal to about 200 mg, less than or equal to about 100 mg, less than or equal to about 50 mg, less than or equal to about 20 mg, or less than or equal to about 10 mg. All suitable combinations of the above-referenced ranges are also possible (e.g., greater than or equal to about 10 mg and less than or equal to about 3000 mg, greater than or equal to about 10 mg and less than or equal to about 1500 mg).

The Gurley stiffness of the protective layer in the cross direction may have any suitable value. In some embodiments, the protective layer has a Gurley stiffness in the cross direction of greater than or equal to about 10 mg, greater than or equal to about 20 mg, greater than or equal to about 50 mg, greater than or equal to about 100 mg, greater than or equal to about 200 mg, greater than or equal to about 500 mg, greater than or equal to about 1000 mg, greater than or equal to about 1500 mg, greater than or equal to about 2000 mg, greater than or equal to about 2500 mg, or greater than or equal to about 3000 mg. In some embodiments, the protective layer has a Gurley stiffness in the cross direction of less than or equal to about 3000 mg, less than or equal to about 2500 mg, less than or equal to about 2000 mg, less than or equal to about 1500 mg, less than or equal to about 1000 mg, less than or equal to about 500 mg, less than or equal to about 200 mg, less than or equal to about 100 mg, less than or equal to about 50 mg, less than or equal to about 20 mg, or less than or equal to about 10 mg. All suitable combinations of the above-referenced ranges are also possible (e.g., greater than or equal to about 10 mg and less than or equal to about 3000 mg, greater than or equal to about 10 mg and less than or equal to about 1500 mg).

In some embodiments, the protective layer has a relatively high tensile strength. In some embodiments, the protective layer has a dry tensile strength in the machine direction of greater than or equal to about 1 lb/in, greater than or equal to about 2 lb/in, greater than or equal to about 5 lb/in, greater than or equal to about 8 lb/in, greater than or equal to about 10 lb/in, greater than or equal to about 15 lb/in, or greater than or equal to about 20 lb/in. In some embodiments, the protective layer has a dry tensile strength in the machine direction of less than or equal to about 20 lb/in, less than or equal to about 15 lb/in, less than or equal to about 10 lb/in, less than or equal to about 8 lb/in, less than or equal to about 5 lb/in, less than or equal to about 2 lb/in, or less than or equal to about 1 lb/in. All suitable combinations of the above-referenced ranges are also possible (e.g., greater than or equal to about 1 lb/in and less than or equal to about 20 lb/in, greater than or equal to about 1 lb/in and less than or equal to about 10 lb/in).

In some embodiments, the protective layer has a relatively high mean flow pore size. In some embodiments, the mean flow pore size of the protective layer is greater than or equal to about 5 μm, greater than or equal to about 10 μm, greater than or equal to about 15 μm, greater than or equal to about 20 μm, greater than or equal to about 30 μm, greater than or equal to about 40 μm, greater than or equal to about 50 μm, greater than or equal to about 60 μm, greater than or equal to about 70 μm, greater than or equal to about 80 μm, greater than or equal to about 90 μm, greater than or equal to about 100 μm, greater than or equal to about 110 μm, or greater than or equal to about 120 μm. In some embodiments, the mean flow pore size of the protective layer is less than or equal to about 120 μm, less than or equal to about 110 μm, less than or equal to about 100 μm, less than or equal to about 90 μm, less than or equal to about 80 μm, less than or equal to about 70 μm, less than or equal to about 60 μm, less than or equal to about 50 μm, less than or equal to about 40 μm, less than or equal to about 30 μm, less than or equal to about 20 μm, less than or equal to about 15 μm, less than or equal to about 10 μm, or less than or equal to about 5 μm. All suitable combinations of the above-referenced ranges are also possible (e.g., greater than or equal to about 5 μm and less than or equal to about 120 μm, greater than or equal to about 10 μm and less than or equal to about 80 μm).

In some embodiments, the ratio of the mean flow pore size of the protective layer to the mean flow pore size of the main filter layer is relatively high. In some embodiments, the mean flow pore size ratio is greater than or equal to about 10, greater than or equal to about 15, greater than or equal to about 20, greater than or equal to about 25, greater than or equal to about 30, greater than or equal to about 35, greater than or equal to about 40, greater than or equal to about 45, greater than or equal to about 50, greater than or equal to about 55, or greater than or equal to about 60. In some embodiments, the mean flow pore size ratio is less than or equal to about 60, less than or equal to about 55, less than or equal to about 50, less than or equal to about 45, less than or equal to about 40, less than or equal to about 35, less than or equal to about 30, less than or equal to about 25, less than or equal to about 20, less than or equal to about 15, or less than or equal to about 10. All suitable combinations of the above-referenced ranges are also possible (e.g., greater than or equal to about 10 and less than or equal to about 60, greater than or equal to about 15 and less than or equal to about 35).

In some embodiments, the protective layer has a relatively high air permeability. In some embodiments, the protective layer has an air permeability greater than or equal to about 100 CFM, greater than or equal to about 120 CFM, greater than or equal to about 200 CFM, greater than or equal to about 300 CFM, greater than or equal to about 400 CFM, greater than or equal to about 500 CFM, or greater than or equal to about 600 CFM. In some embodiments, the protective layer has an air permeability less than or equal to about 600 CFM, less than or equal to about 500 CFM, less than or equal to about 400 CFM, less than or equal to about 300 CFM, less than or equal to about 200 CFM, less than or equal to about 120 CFM, or less than or equal to about 100 CFM. All suitable combinations of the above-referenced ranges are also possible (e.g., greater than or equal to about 100 CFM and less than or equal to about 600 CFM, greater than or equal to about 120 CFM and less than or equal to about 400 CFM).

In some embodiments, the protective layer has a relatively high initial DOP efficiency. In some embodiments, the initial DOP efficiency of the protective layer is greater than or equal to about 1%, greater than or equal to about 2%, greater than or equal to about 5%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, or greater than or equal to about 50%. In some embodiments, the initial DOP efficiency of the protective layer is less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, less than or equal to about 5%, less than or equal to about 2%, or less than or equal to about 1%. All suitable combinations of the above-referenced ranges are also possible (e.g., greater than or equal to about 1% and less than or equal to about 50%, greater than or equal to about 2% and less than or equal to about 15%).

Certain filter media described herein may have beneficial properties, such as relatively high dust-holding capacities. In some embodiments, the filter media has a relatively high dust-holding capacity for both coarse dust and fine dust. Dust-holding capacity is the difference in the weight of the filter media before exposure to a certain amount of dust and the weight of the filter media after the exposure to the dust, upon reaching a particular pressure drop across the filter media, divided by the area of the fiber web. Dust-holding capacity for coarse dust may be measured according to the ASHRAE dust-holding capacity and/or ISO fine dust holding capacity tests described below. Dust-holding capacity for fine dust may be measured according to the NaCl loading test described below. ASHRAE dust-holding capacity may be determined according to the weight (mg) of dust captured per square foot of the media using ASHRAE Standard 52.1 Test Dust with the test area of 1 ft² at 15 fpm velocity where the final pressure drop when the dust holding capacity is measured is 1.5 inches of H₂O on a column. The ASHRAE dust-holding capacity may be determined using the ASHRAE 52.1 (1992) standard.

In some embodiments, the filter media has an ASHRAE dust-holding capacity greater than or equal to about 1 g/ft², greater than or equal to about 1.1 g/ft², greater than or equal to about 1.2 g/ft², greater than or equal to about 1.3 g/ft², greater than or equal to about 1.4 g/ft², greater than or equal to about 1.5 g/ft², greater than or equal to about 2 g/ft², greater than or equal to about 2.5 g/ft², greater than or equal to about 3.0 g/ft², greater than or equal to about 3.5 g/ft², greater than or equal to about 4.0 g/ft², greater than or equal to about 5.0 g/ft², greater than or equal to about 5.5 g/ft², greater than or equal to about 6.0 g/ft², greater than or equal to about 6.5 g/ft², greater than or equal to about 7.0 g/ft², greater than or equal to about 7.5 g/ft², greater than or equal to about 8.0 g/ft², greater than or equal to about 8.5 g/ft², greater than or equal to about 9.0 g/ft², greater than or equal to about 9.5 g/ft², or greater than or equal to about 10 g/ft². In some embodiments, the filter media has an ASHRAE dust-holding capacity of less than or equal to about 10 g/ft², less than or equal to about 9.5 g/ft², less than or equal to about 9.0 g/ft², less than or equal to about 8.5 g/ft², less than or equal to about 8.0 g/ft², less than or equal to about 7.5 g/ft², less than or equal to about 7.0 g/ft², less than or equal to about 6.5 g/ft², less than or equal to about 6.0 g/ft², less than or equal to about 5.5 g/ft², less than or equal to about 5.0 g/ft², less than or equal to about 4.5 g/ft², less than or equal to about 4.0 g/ft², less than or equal to about 3.5 g/ft², less than or equal to about 3.0 g/ft², less than or equal to about 2.5 g/ft², less than or equal to about 2.0 g/ft², less than or equal to about 1.5 g/ft², less than or equal to about 1.4 g/ft², less than or equal to about 1.3 g/ft², less than or equal to about 1.2 g/ft², less than or equal to about 1.1 g/ft², or less than or equal to about 1.0 gift². All suitable combinations of the above-referenced ranges are also possible (e.g., greater than or equal to about 1.0 g/ft² and less than or equal to about 10 g/ft², greater than or equal to about 1.2 g/ft² and less than or equal to about 3.5 g/ft²).

In some embodiments, the filter media has an ISO fine dust-holding capacity greater than or equal to about 80 g/m², greater than or equal to about 90 g/m², greater than or equal to about 100 g/m², greater than or equal to about 110 g/m², greater than or equal to about 120 g/m², greater than or equal to about 130 g/m², greater than or equal to about 140 g/m², or greater than or equal to about 150 g/m². In some embodiments, the filter media has an ISO fine dust-holding capacity less than or equal to about 150 g/m², less than or equal to about 140 g/m², less than or equal to about 130 g/m², less than or equal to about 120 g/m², less than or equal to about 110 g/m², less than or equal to about 100 g/m², less than or equal to about 90 g/m², or less than or equal to about 80 g/m². All suitable combinations of the above-referenced ranges are also possible (e.g., greater than or equal to about 80 g/m² and less than or equal to about 150 g/m², greater than or equal to about 90 g/m² and less than or equal to about 130 g/m²).

The ISO fine dust-holding capacity may be determined using a TOPAS PAF 111 test stand. A 0.13 m² surface area of a filter medium is challenged with ISO fine dust at a concentration of 70 mg/m³ with a face velocity of 5.33 cm/s. The dust-holding capacity is measured when the pressure reaches 450 Pa and is the difference in the weight of the filter medium before the exposure to the fine dust and the weight of the filter medium after the exposure to the fine dust.

In some embodiments, the filter media has a high fine dust (e.g., NaCl) holding capacity. In some embodiments, the filter media has a 0.3 μm NaCl loading capacity (mm H₂O at 5.3 cm/s) of greater than or equal to 30 mm H₂O, greater than or equal to 40 mm H₂O, greater than or equal to 50 mm H₂O, greater than or equal to 60 mm H₂O, greater than or equal to 70 mm H₂O, greater than or equal to 80 mm H₂O, greater than or equal to 90 mm H₂O, greater than or equal to 100 mm H₂O, greater than or equal to 150 mm H₂O, greater than or equal to 200 mm H₂O, or greater than or equal to 300 mm H₂O. In some embodiments, the filter media has a 0.3 μm NaCl loading capacity of less than or equal to about 300 mm H₂O, less than or equal to about 200 mm H₂O, less than or equal to about 100 mm H₂O, less than or equal to about 90 mm H₂O, less than or equal to about 80 mm H₂O, less than or equal to about 70 mm H₂O, less than or equal to about 60 mm H₂O, less than or equal to about 50 mm H₂O, less than or equal to about 40 mm H₂O, or less than or equal to about 30 mm H₂O. All suitable combinations of the above-referenced ranges are also possible (e.g., greater than or equal to about 30 mm H₂O and less than or equal to about 300 mm H₂O, greater than or equal to about 40 mm H₂O and less than or equal to about 200 mm H₂O). To determine NaCl loading, a filter media with nominal exposed area of 100 m² is loaded with NaC1 particles with count media diameter of 0.26 μm. An effective concentration of 15 mg/m³ with media face velocity of 5.3 cm/sec is used. Air resistance (in mm H₂O) is measured after 60 min salt loading.

The filter media may have any suitable basis weight. In some embodiments, the filter media has a basis weight of greater than or equal to about 30 g/m², greater than or equal to about 40 g/m², greater than or equal to about 50 g/m², greater than or equal to about 60 g/m², greater than or equal to about 70 g/m², greater than or equal to about 80 g/m², greater than or equal to about 90 g/m², greater than or equal to about 100 g/m², greater than or equal to about 110 g/m², greater than or equal to about 120 g/m², greater than or equal to about 130 g/m², greater than or equal to about 140 g/m², greater than or equal to about 150 g/m², greater than or equal to about 200 g/m², greater than or equal to about 250 g/m², greater than or equal to about 300 g/m², greater than or equal to about 350 g/m², or greater than or equal to about 400 g/m². In some embodiments, the filter media has a basis weight of less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 140 g/m², less than or equal to about 130 g/m², less than or equal to about 120 g/m², less than or equal to about 110 g/m², less than or equal to about 100 g/m², less than or equal to about 90 g/m², less than or equal to about 80 g/m², less than or equal to about 70 g/m², less than or equal to about 60 g/m², less than or equal to about 50 g/m², less than or equal to about 40 g/m², or less than or equal to about 30 g/m². All suitable combinations of the above-referenced ranges are also possible (e.g., greater than or equal to about 30 g/m² and less than or equal to about 400 g/m², greater than or equal to about 50 g/m² and less than or equal to about 110 g/m²).

In some embodiments, the filter media is relatively thin. In some embodiments, the filter media has a thickness of greater than or equal to about 4 mil, greater than or equal to about 5 mil, greater than or equal to about 6 mil, greater than or equal to about 7 mil, greater than or equal to about 8 mil, greater than or equal to about 9 mil, greater than or equal to about 10 mil, greater than or equal to about 11 mil, greater than or equal to about 12 mil, greater than or equal to about 13 mil, greater than or equal to about 14 mil, greater than or equal to about 15 mil, greater than or equal to about 20 mil, greater than or equal to about 25 mil, greater than or equal to about 30 mil, greater than or equal to about 35 mil, greater than or equal to about 40 mil, greater than or equal to about 50 mil, greater than or equal to about 60 mil, greater than or equal to about 70 mil, greater than or equal to about 80 mil, greater than or equal to about 90 mil, greater than or equal to about 100 mil, greater than or equal to about 110 mil, greater than or equal to about 120 mil, or greater than or equal to about 130 mil. In some embodiments, the filter media has a thickness of less than or equal to about 130 mil, less than or equal to about 120 mil, less than or equal to about 110 mil, less than or equal to about 100 mil, less than or equal to about 90 mil, less than or equal to about 80 mil, less than or equal to about 70 mil, less than or equal to about 60 mil, less than or equal to about 50 mil, less than or equal to about 40 mil, less than or equal to about 35 mil, less than or equal to about 30 mil, less than or equal to about 25 mil, less than or equal to about 20 mil, less than or equal to about 15 mil, less than or equal to about 14 mil, less than or equal to about 13 mil, less than or equal to about 12 mil, less than or equal to about 11 mil, less than or equal to about 10 mil, less than or equal to about 9 mil, less than or equal to about 8 mil, less than or equal to about 7 mil, less than or equal to about 6 mil, less than or equal to about 5 mil, or less than or equal to about 4 mil. All suitable combinations of the above-referenced ranges are also possible (e.g., greater than or equal to about 4 mil and less than or equal to about 130 mil, greater than or equal to about 12 mil and less than or equal to about 30 mil).

In some embodiments, the filter media has a relatively high Gurley stiffness in the machine direction. In some embodiments, the filter media has a Gurley stiffness in the machine direction of greater than or equal to about 150 mg, greater than or equal to about 200 mg, greater than or equal to about 300 mg, greater than or equal to about 400 mg, greater than or equal to about 500 mg, greater than or equal to about 600 mg, greater than or equal to about 700 mg, greater than or equal to about 800 mg, greater than or equal to about 900 mg, greater than or equal to about 1000 mg, greater than or equal to about 1500 mg, greater than or equal to about 2000 mg, greater than or equal to about 2500 mg, greater than or equal to about 3000 mg, or greater than or equal to about 3500 mg. In some embodiments, the Gurley stiffness of the filter media in the machine direction is less than or equal to about 3500 mg, less than or equal to about 3000 mg, less than or equal to about 2500 mg, less than or equal to about 2000 mg, less than or equal to about 1500 mg, less than or equal to about 1000 mg, less than or equal to about 900 mg, less than or equal to about 800 mg, less than or equal to about 700 mg, less than or equal to about 600 mg, less than or equal to about 500 mg, less than or equal to about 400 mg, less than or equal to about 300 mg, less than or equal to about 200 mg, or less than or equal to about 150 mg. All suitable combinations of the above-referenced ranges are also possible (e.g., greater than or equal to about 150 mg and less than or equal to about 3500 mg, greater than or equal to about 200 mg and less than or equal to about 1500 mg).

In some embodiments, the filter media has a relatively high Gurley stiffness in the cross direction. In some embodiments, the filter media has a Gurley stiffness in the cross direction of greater than or equal to about 150 mg, greater than or equal to about 200 mg, greater than or equal to about 300 mg, greater than or equal to about 400 mg, greater than or equal to about 500 mg, greater than or equal to about 600 mg, greater than or equal to about 700 mg, greater than or equal to about 800 mg, greater than or equal to about 900 mg, greater than or equal to about 1000 mg, greater than or equal to about 1500 mg, greater than or equal to about 2000 mg, greater than or equal to about 2500 mg, greater than or equal to about 3000 mg, or greater than or equal to about 3500 mg. In some embodiments, the Gurley stiffness of the filter media in the cross direction is less than or equal to about 3500 mg, less than or equal to about 3000 mg, less than or equal to about 2500 mg, less than or equal to about 2000 mg, less than or equal to about 1500 mg, less than or equal to about 1000 mg, less than or equal to about 900 mg, less than or equal to about 800 mg, less than or equal to about 700 mg, less than or equal to about 600 mg, less than or equal to about 500 mg, less than or equal to about 400 mg, less than or equal to about 300 mg, less than or equal to about 200 mg, or less than or equal to about 150 mg. All suitable combinations of the above-referenced ranges are also possible (e.g., greater than or equal to about 150 mg and less than or equal to about 3500 mg, greater than or equal to about 200 mg and less than or equal to about 1500 mg).

In some embodiments, the filter media has a relatively high tensile strength. In some embodiments, the filter media has a dry tensile strength in the machine direction of greater than or equal to about 2 lb/in, greater than or equal to about 5 lb/in, greater than or equal to about 8 lb/in, greater than or equal to about 10 lb/in, greater than or equal to about 15 lb/in, greater than or equal to about 20 lb/in, greater than or equal to about 30 lb/in, greater than or equal to about 40 lb/in, greater than or equal to about 50 lb/in, or greater than or equal to about 60 lb/in. In some embodiments, the filter media has a dry tensile strength in the machine direction of less than or equal to about 60 lb/in, less than or equal to about 50 lb/in, less than or equal to about 40 lb/in, less than or equal to about 30 lb/in, less than or equal to about 20 lb/in, less than or equal to about 15 lb/in, less than or equal to about 10 lb/in, less than or equal to about 8 lb/in, less than or equal to about 5 lb/in, or less than or equal to about 2 lb/in. All suitable combinations of the above-referenced ranges are also possible (e.g., greater than or equal to about 2 lb/in and less than or equal to about 60 lb/in, greater than or equal to about 8 lb/in and less than or equal to about 30 lb/in).

In some embodiments, the filter media has a relatively high mean flow pore size. In some embodiments, the mean flow pore size of the filter media is greater than or equal to about 0.5 μm, greater than or equal to about 1 μm, greater than or equal to about 2 μm, greater than or equal to about 5 μm, greater than or equal to about 10 μm, greater than or equal to about 15 μm, or greater than or equal to about 20 μm. In some embodiments, the mean flow pore size of the filter media is less than or equal to about 20 μm, less than or equal to about 15 μm, less than or equal to about 10 μm, less than or equal to about 5 μm, less than or equal to about 2 μm, less than or equal to about 1 μm, or less than or equal to about 0.5 μm. All suitable combinations of the above-referenced ranges are also possible (e.g., greater than or equal to about 0.5 μm and less than or equal to about 20 μm, greater than or equal to about 1 μm and less than or equal to about 20 μm).

In some embodiments, the filter media has a relatively high air permeability. In some embodiments, the filter media has an air permeability of greater than or equal to about 10 CFM, greater than or equal to about 15 CFM, greater than or equal to about 20 CFM, greater than or equal to about 30 CFM, greater than or equal to about 40 CFM, greater than or equal to about 50 CFM, greater than or equal to about 60 CFM, greater than or equal to about 70 CFM, greater than or equal to about 80 CFM, greater than or equal to about 90 CFM, greater than or equal to about 100 CFM, greater than or equal to about 110 CFM, greater than or equal to about 120 CFM, greater than or equal to about 130 CFM, greater than or equal to about 140 CFM, or greater than or equal to about 150 CFM. In some embodiments, the filter media has an air permeability of less than or equal to about 150 CFM, less than or equal to about 140 CFM, less than or equal to about 130 CFM, less than or equal to about 120 CFM, less than or equal to about 110 CFM, less than or equal to about 100 CFM, less than or equal to about 90 CFM, less than or equal to about 80 CFM, less than or equal to about 70 CFM, less than or equal to about 60 CFM, less than or equal to about 50 CFM, less than or equal to about 40 CFM, less than or equal to about 30 CFM, less than or equal to about 20 CFM, less than or equal to about 15 CFM, or less than or equal to about 10 CFM. All suitable combinations of the above-referenced ranges are also possible (e.g., greater than or equal to about 10 CFM and less than or equal to about 150 CFM, greater than or equal to about 15 CFM and less than or equal to about 80 CFM).

The filter media may have a relatively high initial DOP efficiency. In some embodiments, the initial DOP efficiency of the filter media is greater than or equal to about 20%, greater than or equal to about 30%, greater than or equal to about 40%, greater than or equal to about 50%, or greater than or equal to about 60%, greater than or equal to about 70%, greater than or equal to about 80%, greater than or equal to about 90%, greater than or equal to about 95%, or greater than or equal to about 99%. In some embodiments, the initial DOP efficiency of the filter media is less than or equal to about 99%, less than or equal to about 95%, less than or equal to about 90%, less than or equal to about 80%, less than or equal to about 70%, less than or equal to about 60%, less than or equal to about 50%, less than or equal to about 40%, less than or equal to about 30%, or less than or equal to about 20%. All suitable combinations of the above-referenced ranges are also possible (e.g., greater than or equal to about 20% and less than or equal to about 99%, greater than or equal to about 50% and less than or equal to about 98%).

The filter media may have a relatively high gamma value. In some embodiments, the filter media has a gamma value greater than or equal to 10, greater than or equal to 15, greater than or equal to 20, greater than or equal to 30, greater than or equal to 40, or greater than or equal to 50. In some embodiments, the gamma value of the filter media is less than or equal to 50, less than or equal to 40, less than or equal to 30, less than or equal to 20, less than or equal to 15, or less than or equal to 10. All suitable combinations of the above-referenced ranges are also possible (e.g., greater than or equal to about 10 and less than or equal to about 50, greater than or equal to about 15 and less than or equal to about 50).

In some embodiments, the filter media has a relatively high Mullen burst strength. In some embodiments, the filter media has a Mullen burst strength of greater than or equal to 20 psi, greater than or equal to 30 psi, greater than or equal to 40 psi, greater than or equal to 50 psi, greater than or equal to 100 psi, greater than or equal to 150 psi, greater than or equal to 200 psi, or greater than or equal to 250 psi. In some embodiments, the filter media has a Mullen burst strength of less than or equal to 250 psi, less than or equal to 200 psi, less than or equal to 150 psi, less than or equal to 100 psi, less than or equal to 50 psi, less than or equal to 40 psi, less than or equal to 30 psi, or less than or equal to 20 psi. All suitable combinations of the above-referenced ranges are also possible (e.g., greater than or equal to about 20 psi and less than or equal to about 250 psi, greater than or equal to about 30 psi and less than or equal to about 150 psi).

During or after formation of a filter media, the filter media may be further processed according to a variety of known techniques. For instance, a coating method may be used to include a resin in the filter media. Optionally, additional layers can be formed and/or added to a filter media using processes such as adhesives, lamination, co-pleating, or collation. For example, in some cases, two layers are formed into a composite article by a wet-laid process as described above, and the composite article is then combined with a third layer by any suitable process (e.g., adhesives, lamination, co-pleating, or collation). It can be appreciated that a filter media or a composite article formed by the processes described herein may be suitably tailored not only based on the components of each layer, but also according to the effect of using multiple layers of varying properties in appropriate combination to form filter media having the characteristics described herein.

As described herein, in some embodiments two or more layers of the filter media (e.g., pre-filter layer, main filter layer, protective layer) may be formed separately and combined by any suitable method. Non-limiting examples of suitable methods include lamination, collation, and use of adhesives. The two or more layers may be formed using different processes, or the same process. For example, each of the layers may be independently formed by a wet-laid process, a non-wet-laid process (e.g., melt-blown process, melt spinning process, centrifugal spinning process, electrospinning process, dry laid process, air-laid process), or any other suitable process.

Different layers may be adhered together by any suitable method. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

In some embodiments, further processing may involve pleating the filter media. For instance, two layers may be joined by a co-pleating process. In some cases, the filter media, or various layers thereof, may be suitably pleated by forming score lines at appropriately spaced distances apart from one another, allowing the filter media to be folded. In some cases, one layer can be wrapped around a pleated layer. It should be appreciated that any suitable pleating technique may be used.

In some embodiments, a filter media can be post-processed such as subjected to a corrugation process to increase surface area within the web. In other embodiments, a filter media may be embossed.

The filter media may include any suitable number of layers, e.g., at least 2, at least 3, at least 4, or at least 5 layers. In some embodiments, the filter media may include up to 10 layers.

Filter media described herein may be used in an overall filtration arrangement or filter element. In some embodiments, one or more additional layers or components are included with the filter media. Non-limiting examples of additional layers (e.g., a third layer, a fourth layer) include a meltblown layer, a wet laid layer, a spunbond layer, a carded layer, an air-laid layer, a spunlace layer, a forcespun layer or an electrospun layer.

It should be appreciated that the filter media may include other parts in addition to the one or more layers described herein. In some embodiments, further processing includes incorporation of one or more structural features and/or stiffening elements. For instance, the filter media may be combined with additional structural features such as polymeric and/or metallic meshes. In one embodiment, a screen backing may be disposed on the filter media, providing for further Gurley stiffness. In some cases, a screen backing may aid in retaining the pleated configuration. For example, a screen backing may be an expanded metal wire or an extruded plastic mesh.

The filter media may be incorporated into a variety of suitable filter elements for use in various applications including gas and liquid filtration. Filter media suitable for gas filtration may be used for HVAC, HEPA, face mask, and ULPA filtration applications. For example, the filter media may be used in heating and air conditioning ducts. In another example, the filter media may be used for respirator and face mask applications (e.g., surgical face masks, industrial face masks, and industrial respirators).

Filter elements may have any suitable configuration as known in the art including bag filters and panel filters. Filter assemblies for filtration applications can include any of a variety of filter media and/or filter elements. The filter elements can include the above-described filter media. Examples of filter elements include gas turbine filter elements, dust collector elements, heavy duty air filter elements, automotive air filter elements, air filter elements for large displacement gasoline engines (e.g., SUVs, pickup trucks, trucks), HVAC air filter elements, HEPA filter elements, ULPA filter elements, vacuum bag filter elements, fuel filter elements, and oil filter elements (e.g., lube oil filter elements or heavy duty lube oil filter elements).

Filter elements can be incorporated into corresponding filter systems (gas turbine filter systems, heavy duty air filter systems, automotive air filter systems, HVAC air filter systems, HEPA filter systems, ULPA filter system, vacuum bag filter systems, fuel filter systems, and oil filter systems). The filter media can optionally be pleated into any of a variety of configurations (e.g., panel, cylindrical).

Filter elements can also be in any suitable form, such as radial filter elements, panel filter elements, or channel flow elements. A radial filter element can include pleated filter media that are constrained within two open wire meshes in a cylindrical shape. During use, fluids can flow from the outside through the pleated media to the inside of the radial element.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by any suitable method, e.g., by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. It should be understood that the filter media and filter elements may have a variety of different constructions and the particular construction depends on the application in which the filter media and elements are used. In some cases, a substrate may be added to the filter media.

The filter elements may have the same property values as those noted above in connection with the filter media. For example, the above-noted pressure drop and efficiency values may also be found in filter elements.

During use, the filter media mechanically trap contaminant particles on the filter media as fluid (e.g., air) flows through the filter media. The filter media need not be electrically charged to enhance trapping of contamination. Thus, in some embodiments, the filter media are not electrically charged. However, in some embodiments, the filter media may be electrically charged. Charge may be induced on the filter media by a charging process (e.g., a corona charging process, a triboelectric charging process, a hydro charging process, or an ion beam charging process).

### EXAMPLE 1

This example describes five filter media comprising a dual-phase pre-filter layer. The dust-holding capacities and mechanical stiffness values of these five filter media were compared to the corresponding properties of a filter media comprising a single-phase pre-filter layer.

Five filter media samples (labeled Samples 1-5) comprising a dual-phase pre-filter layer, a main filter layer, and a protective layer were formed. In each of Samples 1-5, a wet-laid dual-phase pre-filter layer was positioned upstream and directly adjacent to a main filter layer, and a protective layer was positioned downstream and directly adjacent to the main filter layer. The main filter layer was an electrospun polyamide fiber web having an average fiber diameter of 120 nm. The entire filter media had an F9 efficiency rating according to the EN779 standard. Each dual-phase pre-filter layer included a first phase (e.g., a coarse phase) and a second phase (e.g., a tight phase). The coarse phase contained a blend of 0.5 denier fibers having a diameter of 7.1 μm, 1.7 dtex fibers having a diameter of 12.4 μm, and bi-component binder fibers (multi-component binder fibers) having a diameter of 16.1 μm. The tight phase contained a blend of Cyphrex fibers having a diameter of 2.5 μm, 1.7 dtex fibers having a diameter of 12.4 μm, and bi-component binder fibers having a diameter of 16.1 μm. Each pre-filter layer was saturated with binder resins, with a resin content of about 15±5 wt %. The specific compositions of the pre-filter layers of Samples 1-5 are shown in Table 1.

In addition, a filter media sample (labeled Comparative Sample 1) comprising a single-phase pre-filter layer, a main filter layer, and a protective layer was formed. In Comparative Sample 1, a wet-laid single-phase pre-filter layer was positioned upstream and directly adjacent to a main filter layer, and a protective layer was positioned downstream and directly adjacent to the main filter layer. Like the main filter layer of Samples 1-5, the main filter layer of Comparative Sample 1 was an electrospun polyamide fiber web having an average fiber diameter of 120 nm, and the filter had an F9 efficiency rating according to the EN779 standard. The single-phase pre-filter layer contained a blend of Cyphrex, 0.5 denier fibers, 1.7 dtex fibers, and binder fibers. The pre-filter layer was saturated with binder resins with a resin content of about 15±5 wt %. Table 1 shows the specific composition of Comparative Sample 1.

TABLE 1
Composition of Samples

| | Ratio of Coarse | Coarse Phase | Tight Phase |
|---|---|---|---|
| Sample | to Tight Phase | Composition | Composition |
| 1 | 40 gsm:40 gsm | 80% 0.5 den, | 20% Cyphrex, |
| | | 12% 1.7 dtex | 72% 1.7 dtex |
| 2 | 40 gsm:40 gsm | 51% 0.5 den, | 20% Cyphrex, |
| | | 40% 1.7 dtex | 72% 1.7 dtex |
| 3 | 40 gsm:40 gsm | 51% 0.5 den, | 30% Cyphrex, |
| | | 40% 1.7 dtex | 62% 1.7 dtex |
| 4 | 40 gsm:40 gsm | 80% 0.5 den, | 30% Cyphrex, |
| | | 12% 1.7 dtex | 62% 1.7 dtex |
| 5 | 80 gsm | 52% 0.5 den, | 92% 0.5 den |
| | | 50% 1.7 dtex | |

| | | |
|---|---|---|
| Comparative | 70 gsm | 13% Cyphrex, 46% 0.5 den, |
| Sample 1 | | 33% 1.7 dtex |

In addition, in each of Samples 1-5 and Comparative Sample 1, each phase contained 8 wt % of binder fibers, including bi-component fibers.

Based on the data in Table 1, the SAFD of the coarse phase and the tight phase of each of Samples 1-5 were determined by the following equation:

d=Σ(mᵢ/ρᵢ)/Σ(mᵢ/dᵢρᵢ)

The SAFD of Comparative Sample 1 was similarly determined. In addition, the thickness of each of Samples 1-5 and Comparative Sample 1 were measured according to the TAPPI T411 (1997) protocol. The SAFD and thickness values for the filter media are provided in Table 2.

TABLE 2
Thickness and SAFD Values

| | | Coarse | Tight | SAFD |
|---|---|---|---|---|
| | | phase | phase | ratio |
| | Thickness | SAFD | SAFD | (coarse: |
| Sample | (mil) | (μm) | (μm) | tight) |
| 1 | 36 | 7.4 | 5.3 | 1.40 |
| 2 | 28 | 8.6 | 5.3 | 1.62 |
| 3 | 30 | 12.5 | 9.4 | 1.33 |
| 4 | 27 | 7.4 | 4.4 | 1.68 |
| 5 | 27 | 8.6 | 4.4 | 1.95 |
| Comparative | 26 | 4.9 | 4.9 | 1.00 |
| Sample 1 | | | | |

The coarse and fine dust-holding capacities for each filter media were measured. Coarse dust-holding capacity was evaluated based on the ASHRAE dust-holding capacity and ISO fine dust-holding capacity tests described above, and fine dust-holding capacity was evaluated based on the NaCl loading test described above.

TABLE 3
Dust-Holding Capacities

| | ASHRAE | ISO Fine | NaCl |
|---|---|---|---|
| | DHC | DHC (g) | loading |
| Sample | (g/ft²) | at 450 Pa | (mmW) |
| 1 | 2.7 | 7.9 | 79.30 |
| 2 | 1.9 | 6.4 | 88.40 |
| 3 | 2 | 6.3 | 86.60 |
| 4 | 1.7 | 5.6 | 69.50 |
| 5 | 1.6 | 5.1 | 63.60 |
| Comparative | 1.5 | 4.9 | 66.00 |
| Sample 1 | | | |

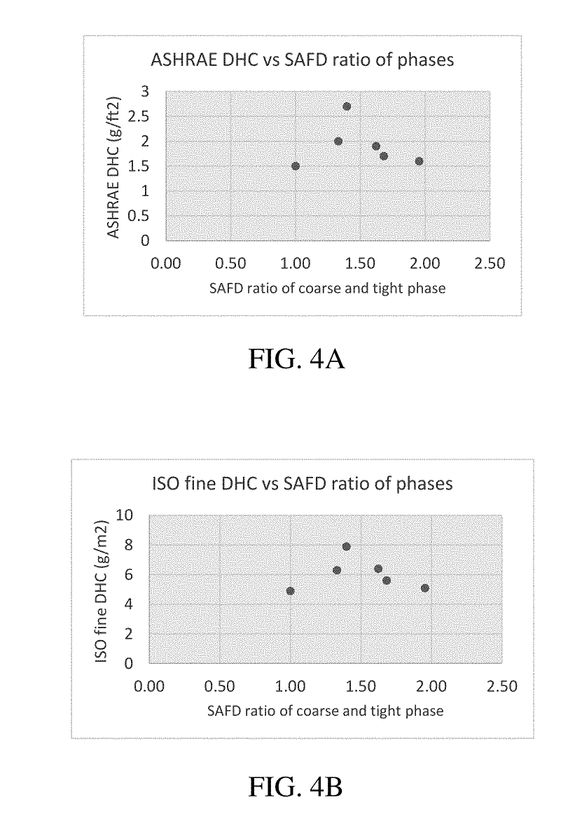

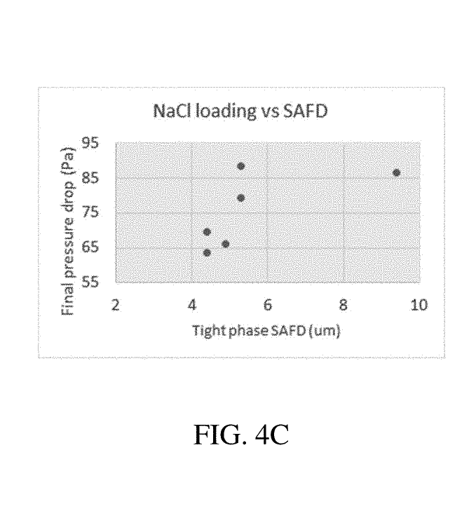

The coarse dust-holding capacities of Samples 1-5 and Comparative Sample 1 were plotted as a function of the ratio of the SAFD of the coarse phase to the SAFD of the tight phase of the pre-filter layer. FIG. 4A shows a plot of ASHRAE dust-holding capacity as a function of SAFD ratio, and FIG. 4B shows a plot of ISO fine dust-holding capacity as a function of SAFD ratio. FIGS. 4A-4B demonstrate that filter media having an SAFD ratio in the range of about 1.2 to about 1.6 had improved coarse dust-holding capacity (e.g., ASHRAE DHC, ISO fine dust DHC) compared to filter media having an SAFD ratio outside of this range.

The fine dust-holding capacities of Samples 1-5 and Comparative Sample 1 were plotted as a function of the SAFD of the tight phase (second phase). FIG. 4C shows a plot of NaCl loading (final pressure drop in Pa) as a function of the SAFD of the tight phase. FIG. 4C demonstrates that filter media having a tight phase SAFD of 3-5 μm had improved NaCl loading compared to filter media having an SAFD outside of this range.

In addition to the performance properties of the sample filter media, certain mechanical properties were measured. Gurley stiffnesses (bending resistance) in the machine direction and cross direction were determined in accordance with TAPPI T543 om-94 (2000). Table 4 provides the machine direction Gurley stiffness values for each sample.

TABLE 4
Gurley Stiffness

| | Machine |
|---|---|
| | direction |
| | Gurley |
| Sample | stiffness (mg) |
| 1 | 793 |
| 2 | 1060 |
| 3 | 997 |
| 4 | 860 |
| 5 | 972 |
| Comparative | 638 |
| Sample 1 | |

### EXAMPLE 2

This example describes the average fiber diameters of Samples 1 and 5 from Example 1. A plot of these diameters demonstrates that each of Samples 1 and 5 had a gradient in average fiber diameter across the thickness of the pre-filter layer that may be characterized by two exponential functions.

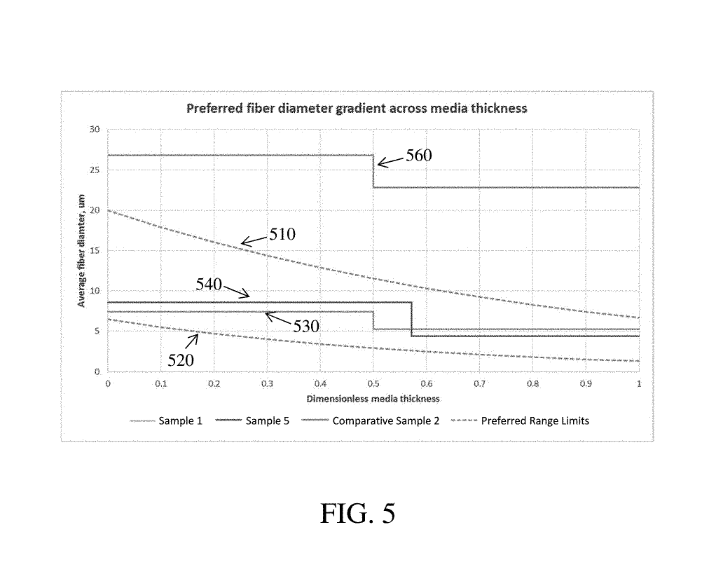

FIG. 5, which is a plot of average fiber diameter as a function of normalized thickness, shows a first exponential function 510 and a second exponential function 520. First exponential function 510 had the following form:

$$f ( x ) = \frac{20}{{( exp ( 0.5 * x ) )}^{2}}$$

Second exponential function 520 had the following form:

$$f ( x ) = \frac{6.5}{{( exp ( 0.8 * x ) )}^{2}}$$

In addition, FIG. 5 shows line 530 representing the average fiber diameter values of Sample 1 as a function of normalized thickness and line 540 representing the average fiber diameter values of Sample 5 as a function of normalized thickness. As shown in FIG. 5, lines 530 and 540 both fall between first exponential function 510 and second exponential function 520. In particular, lines 530 and 540 are greater than or equal to second exponential function 520 and less than or equal to first exponential function 510.

In contrast, FIG. 5 also shows line 560 representing the average fiber diameter values of a prior art filter media comprising a dual-phase layer comprising cellulose fibers. In particular, line 560 corresponds to average fiber diameter values for Dual-Phase Layer Sample 1 from U.S. Pat. No. 9,283,501, which is labeled in FIG. 5 as Comparative Sample 2. As shown in FIG. 5, line 560 falls outside the range between first exponential function 510 and second exponential function 520.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media, comprising:
a pre-filter layer, comprising:
a first phase comprising a first plurality of fibers, wherein the first phase has a surface average fiber diameter (SAFD) of greater than or equal to about 3 μm and less than or equal to about 30 μm; and
a second phase comprising a second plurality of fibers, wherein the second phase has an SAFD of greater than or equal to about 0.5 μm and less than or equal to about 20 μm,
wherein a ratio of the SAFD of the first phase to the SAFD of the second phase is greater than or equal to about 1.2 and less than or equal to about 6,
wherein the pre-filter layer has a Gurley stiffness in the machine direction of greater than or equal to about 150 mg, and
wherein the pre-filter layer has an air permeability of greater than about 80 CFM.

2. The filter media of claim 1, wherein the pre-filter layer further comprises an intermediate phase comprising at least a portion of the first and second plurality of fibers, wherein the intermediate phase is positioned between the first phase and the second phase, and wherein the intermediate phase has an SAFD between the SAFD of the first phase and the SAFD of the second phase.

3. The filter media of any one of claim 1, wherein the pre-filter layer comprises a wet-laid non-woven web.

4. The filter media of any one of claim 1, wherein the first plurality of fibers and/or the second plurality of fibers comprise synthetic fibers.

5. The filter media of claim 3, wherein the synthetic fibers comprise a polyester, a co-polyester, a modified polyester, a polyolefin, a polyacrylonitrile, an aramid, and/or a modified cellulose.

6. The filter media of any one of claim 1, wherein at least about 5% of fibers in the second phase have an average fiber diameter of less than or equal to about 5 μm.

7. The filter media of any one of claim 1, wherein the first plurality of fibers and/or the second plurality of fibers comprise bi-component fibers.

8. The filter media of any one of claim 1, wherein the pre-filter layer has an air permeability of greater than or equal to 100 CFM.

9. The filter media of any one of claim 1, wherein an average fiber diameter at four or more locations along a thickness of the pre-filter layer is greater than or equal to any exponential function having the form:
$$\frac{{B}_{min}}{{( exp ( {A}_{max} * x ) )}^{2}} ,$$
and less than or equal to any exponential function having the form:
$$\frac{{B}_{max}}{{( exp ( {A}_{min} * x ) )}^{2}} ,$$
wherein:
Bₘᵢₙ is greater than or equal to about 3 μm,
Bₘₐₓ is less than or equal to about 30 μm,
Aₘᵢₙ is greater than or equal to about 0.2,
Aₘₐₓ is less than or equal to about 1.2, and
x corresponds to a location along the thickness of the pre-filter and is normalized to have a value of greater than or equal to about 0 and less than or equal to about 1.

10. The filter media of claim 9, wherein Bₘᵢₙ is greater than or equal to about 6.5 μm, Bₘₐₓ is less than or equal to about 20 μm, Aₘᵢₙ is greater than or equal to about 0.5, and Aₘₐₓ is less than or equal to about 0.8.

11. A filter media, comprising:
a pre-filter layer, comprising:
a first phase comprising a first plurality of fibers, wherein the first phase has a surface average fiber diameter (SAFD) of greater than or equal to about 3 μm and less than or equal to about 30 μm; and
a second phase comprising a second plurality of fibers, wherein the second phase has an SAFD of greater than or equal to about 0.5 μm and less than or equal to about 20 μm,
wherein a ratio of the SAFD of the first phase to the SAFD of the second phase is greater than or equal to about 1.2 and less than or equal to about 6; and
a main filter layer comprising a third plurality of fibers, wherein the main filter layer has an SAFD of less than the SAFD of the second phase of the pre-filter layer, wherein the main filter layer has an average fiber diameter of greater than or equal to 70 nm and less than or equal to 1 μm,
wherein a ratio of a thickness of the pre-filter to a thickness of the main filter layer is greater than or equal to 8.

12. The filter media of claim 11, wherein the pre-filter layer further comprises an intermediate phase comprising at least a portion of the first and second plurality of fibers, wherein the intermediate phase is positioned between the first phase and the second phase, and wherein the intermediate phase has an SAFD between the SAFD of the first phase and the SAFD of the second phase.

13. The filter media of claim 11, wherein the filter media further comprises a protective layer comprising a fourth plurality of fibers, wherein the protective layer has an SAFD greater than the SAFD of the main filter layer.

14. The filter media of claim 11, wherein the filter media has an ASHRAE dust holding capacity of greater than or equal to about 1 g/ft², an ISO fine dust holding capacity of greater than or equal to about 80 g/m², and an NaCl loading of greater than or equal to about 30 mm H₂O.

15. The filter media of claim 11, wherein the filter media has a Gurley stiffness in the machine direction of greater than or equal to about 150 mg.

16. The filter media of claim 11, wherein the filter media has an air permeability of greater than about 80 CFM.

17. The filter media of claim 11, wherein the main filter layer has a thickness of greater than or equal to about 0.0001 mil and less than or equal to about 4 mil.

18. The filter media of claim 11, wherein at least 5% fibers in the second phase of the pre-filter layer have an average fiber diameter less than or equal to about 5 μm.

19. The filter media of claim 11, wherein the pre-filter layer has a Gurley stiffness in the machine direction of greater than or equal to about 150 mg.

20. The filter media of claim 11, wherein the pre-filter layer has an air permeability of greater than 80 CFM.
